(19) United States
(12) Patent Application Publication
(10) Pub. No.: US 2008/0219470 A1
(43) Pub. Date: Sep. 11, 2008

(54) Signal processing apparatus, signal processing method, and program recording medium

(75) Inventor: Tadaaki Kimijima, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/074,687

(22) Filed: Mar. 5, 2008

(30) Foreign Application Priority Data
Mar. 8, 2007 (JP) JP2007-058825

(51) Int. Cl. H04R 3/00

(52) U.S. Cl. 381/92

(57) ABSTRACT

A signal processing apparatus includes a receiving unit configured to receive an audio signal, and a noise reducing unit configured to reduce a wind noise component of the audio signal received by the receiving unit by reducing a signal component that has a frequency less than or equal to a predetermined frequency and that is localized in a different manner from a specified manner.

### CROSS REFERENCES TO RELATED APPLICATIONS

The present invention contains subject matter related to Japanese Patent Application JP 2007-058825 filed in the Japanese Patent Office on Mar. 8, 2007, the entire contents of which are incorporated herein by reference.

### BACKGROUND OF THE INVENTION

1. Field of the Invention

The present invention relates to a signal processing apparatus and method therefor adapted to perform processing for noise reduction of an input audio signal, and a recording medium on which a processing program therefor is recorded.

2. Description of the Related Art

Recording apparatuses having a microphone and configured to pick up and record external sound, such as a video camera system, have a problem in that noise called wind noise is generated by turbulent airflow over a microphone unit and is recorded when the sound is picked up. The wind noise has a frequency component that is predominantly in a low-frequency range of about 1 kHz or less, and is unwanted sounds such as buzz and hum.

One technique of the related art for reducing such 3186892. A wind noise reduction device disclosed in Japanese Patent No. 3186892 includes a high pass fitter (HPF) that allows a component of an input signal having a frequency more than or equal to a predetermined frequency to pass through, and a wind noise detector that detects wind noise from the input signal, wherein a frequency characteristic of the HPF is controlled by an output signal of the wind noise detector.

As described above, wind noise has a feature that its frequency components are predominantly in a low-frequency range of about 1 kHz or less. Thus, low-frequency sound waves are attenuated by the HPF according to the detected level of wind noise, thereby suppressing the wind noise.

### SUMMARY OF THE INVENTION

The device disclosed in the above publication has a problem. In a case where a wind is blowing, the HPF is applied to all audio signals and wind noise is suppressed; however, a low-frequency component of an audio signal to be picked up may also be attenuated. This leads to an unwanted significant change in timbre, which causes inconvenience such as difficulty listening to a speaker's voice.

It is therefore desirable to propose a technique that allows only wind noise to be suppressed without impairing the sound quality of an audio signal to be picked up. A signal processing apparatus according to an embodiment of the present invention includes the following elements.

Receiving means receives an audio signal. Noise reducing means reduces a wind noise component of the audio signal received by the receiving means by reducing a signal component that has a frequency less than or equal to a predetermined frequency and that is localized in a different manner from a specified manner.

The signal processing apparatus may be further configured such that the noise reducing means reduces a signal component that has a frequency less than or equal to the predetermined frequency and that is localized outside a specified localization angle to reduce the wind noise component.

Alternatively, the noise reducing means may reduce a signal component that has a frequency less than or equal to the predetermined frequency and that has a localization angle changing in a different manner from a specified manner in a time axis direction to reduce the wind noise component.

Alternatively, the noise reducing means may reduce a signal component that has a frequency less than or equal to the predetermined frequency and for which a difference between a localization angle of the signal component and a localization angle of a signal component of an adjacent frequency band is greater than a predetermined value to reduce the wind noise component.

Further, the noise reducing means may reduce a wind noise component of the audio signal received by the receiving means by reducing a signal component that has a frequency less than or equal to a predetermined frequency and that has a localization angle with a low correlation in a time axis direction.

Alternatively, the noise reducing means may reduce a wind noise component of the audio signal received by the receiving means by reducing a signal component that has a frequency less than or equal to a predetermined frequency and that has a localization angle with a low correlation with an adjacent frequency band.

For example, in a case where sound is picked up using a stereo microphone or the like, an audio signal to be picked up, such as a speaker's voice, is generally concentrated in the center while an unwanted signal component such as ambient sounds and noise is generally localized in end areas. In view of this feature and the above-described feature of wind noise (whose main component has a frequency of 1 kHz or less), according to an embodiment of the present invention, a signal component that has a frequency less than or equal to a predetermined frequency and that is outside a specified localization angle (localization position) is reduced to thereby suppress a wind noise component without impairing the sound quality of an audio signal to be picked up.

As described above, wind noise is caused by turbulent airflow over a microphone unit when sound is picked up. Because of the nature of wind noise, a picked-up audio signal of wind noise has a feature that a signal waveform of each channel is random or uncorrelated. Such a random or uncorrelated signal waveform of each channel means that, as viewed along a time axis, a wind noise component has a localization angle (localization position) that changes in a largely different manner from that of localization positions of other signal components. In view of this feature, therefore, according to an embodiment of the present invention, a signal component that has a frequency less than or equal to a predetermined frequency and that has a localization angle changing in a different manner from a specified manner in a time axis direction is reduced to thereby suppress wind noise without impairing the sound quality of an audio signal to be picked up.

Further, such a random or uncorrelated signal waveform of each channel as described above can mean that, in another point of view, a difference between a localization position of a wind noise component and a localization position of a signal component in a adjacent frequency band is significantly greater than other differences. In view of this point, therefore, according to an embodiment of the present invention, a signal component that has a frequency less than or equal to a predetermined frequency and for which a difference between a localization angle of the signal component and that of a signal component in an adjacent frequency band is greater than a specified value is reduced to thereby suppress wind noise without impairing the sound quality of an audio signal to be picked up.

According to the embodiment of the present invention, therefore, a signal component of an input audio signal that has a frequency less than or equal to a predetermined frequency and that is localized in a different manner from a specified manner is reduced, whereby only a wind noise component can be suppressed.

Further, because of the above-described feature of a wind noise component that a waveform of the wind noise component is random or uncorrelated, the wind noise component can also be determined to have a localization position that randomly changes in a time axis direction. In other words, the wind noise component can be observed as a component that has a localization position with a low correlation in the time axis direction.

Furthermore, the feature of the wind noise component that the signal waveform is random or uncorrelated can be determined to provide a localization position with a low correlation with a signal component in an adjacent frequency band in a frequency axis direction.

In view of those features, according to an embodiment of the present invention, therefore, a signal component that has a frequency less than or equal to a predetermined frequency and that has a localization angle with a low correlation in a time axis direction, or a signal component that has a frequency less than or equal to a predetermined frequency and that has a localization angle with a low correlation with an adjacent frequency band is reduced, whereby only a wind noise component can be suppressed.

According to the embodiments of the present invention, therefore, only a wind noise component can be suppressed without impairing the sound quality of an audio signal to be picked up.

### BRIEF DESCRIPTION OF THE DRAWINGS

FIG. 1 is a block diagram showing an internal structure of a video camera system including a signal processing apparatus according to an embodiment of the present invention;

FIG. 2 is a block diagram showing an internal structure of a signal processing apparatus according to a first example of a first embodiment of the present invention;

FIG. 3 is a block diagram showing an internal structure of a signal processing apparatus according to a second example of the first embodiment;

FIG. 4 is a flowchart showing a processing operation to be executed by the signal processing apparatus according to the second example of the first embodiment;

FIG. 5 is a block diagram showing an internal structure of a signal processing apparatus according to a third example of the first embodiment;

FIG. 6 is a block diagram showing an internal structure of a signal processing apparatus according to a fourth example of the first embodiment;

FIG. 7 is a block diagram showing an internal structure of a localization-angle calculation circuit provided in the signal processing apparatus according to the fourth example of the first embodiment;

FIG. 8 is a flowchart showing a processing operation to be executed when the signal processing apparatus according to the fourth example of the first embodiment is implemented in software;

FIG. 9 is a block diagram showing an internal structure of a signal processing apparatus according to a fifth example of the first embodiment;

FIG. 10 is a block diagram showing an internal structure of a signal processing apparatus according to a sixth example of the first embodiment;

FIG. 11 is a block diagram showing an internal structure of a signal processing apparatus according to a second embodiment of the present invention;

FIG. 12 is a flowchart showing a processing operation to be executed when the signal processing apparatus according to the second embodiment is implemented in software;

FIG. 13 is a block diagram showing an internal structure of a signal processing apparatus according to a third embodiment of the present invention;

FIG. 14 is a flowchart showing a processing operation to be executed when the signal processing apparatus according to the third embodiment is implemented in software;

FIG. 15 is a block diagram showing an internal structure of a signal processing apparatus according to a first modification of the present invention;

FIG. 16 is a block diagram showing an internal structure of a localization-angle/level calculation circuit provided in the signal processing apparatus according to the first modification;

FIG. 17 is a block diagram showing an internal structure of a video camera system according to a second modification of the present invention;

FIGS. 18A and 18B are flowcharts showing processing operations executed to implement the video camera system according to the second modification;

FIG. 19 is a block diagram showing an internal structure of a video camera system according to a third modification of the present invention; and

FIGS. 20A and 20B are flowcharts showing processing operations executed to implement the video camera system according to the third modification.

### DESCRIPTION OF THE PREFERRED EMBODIMENTS

Embodiments of the present invention will be described hereinafter.

### First Embodiment

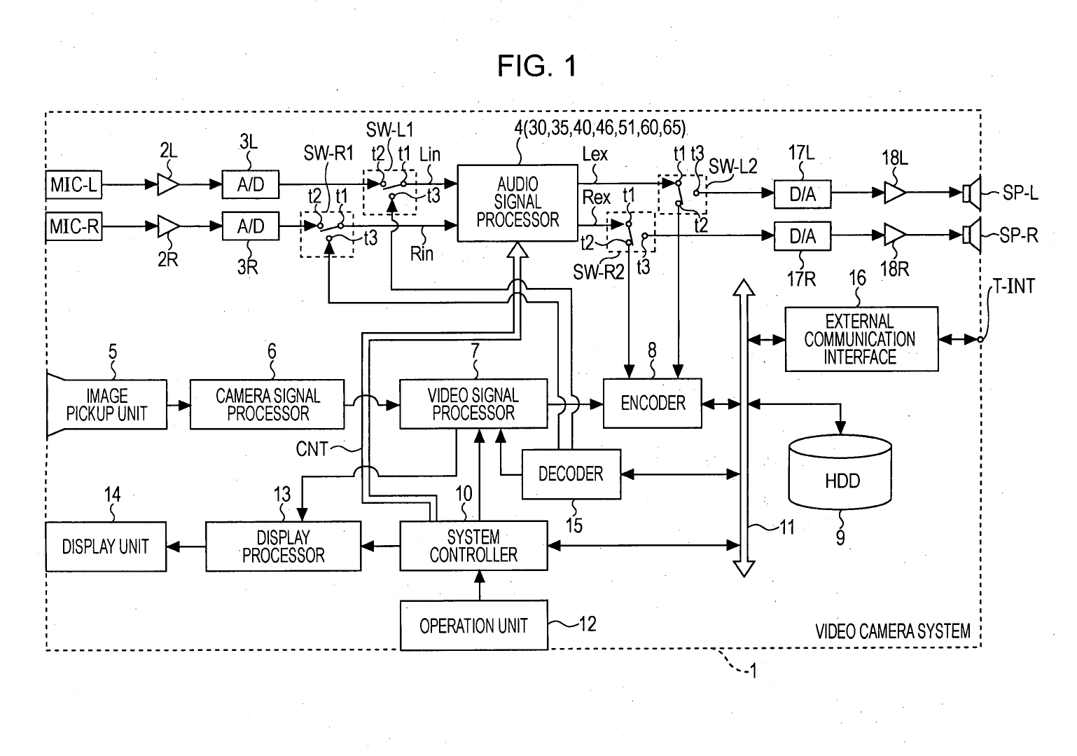

FIG. 1 is a block diagram showing an internal structure of a video camera system 1 including a signal processing apparatus according to an embodiment of the present invention.

Referring to FIG. 1, the video camera system 1 is configured to record a video signal based on an image pickup signal obtained by an image pickup unit 5. The video camera system 1 is also configured to record, in addition to a picked up image, an audio signal picked up by a stereo microphone including a left-channel (Lch) microphone MIC-L and a right-channel (Rch) microphone MIC-R synchronously with the picked up image.

The image pickup unit 5 includes a camera lens optical system operable to pick up an image, and an image pickup element such as a charge-coupled device (CCD) sensor. The image pickup unit 5 supplies an electrical signal corresponding to a picked up image to a camera signal processor 6.

The camera signal processor 6 applies, for example, gain adjustment or sample-hold processing on an analog image pickup signal that is supplied as the electrical signal from the image pickup unit 5 to perform waveform shaping to obtain a video signal. The video signal is supplied to a video signal processor 7.

The video signal processor 7 performs predetermined video signal processing on the input video signal to generate a standard color television signal complying with the National Television System Committee (NTSC) standard or the Phase Alternation by Line (PAL) standard, in which a luminance signal Y and two color-difference signals R-Y and B-Y, which are used for, for example, color television broadcasting, are multiplexed. The video signal based on a color television signal is supplied to an encoder 8 described below.

In the image pickup process, a picked up image is displayed on a display unit 14 such as a liquid crystal display. In this case, the video signal processor 7 also supplies the video signal to a display processor 13. The display processor 13 controls the driving of the display unit 14 based on the video signal to display an image corresponding to the picked up image on the display unit 14.

An audio signal picked up by the Lch microphone MIC-L (hereinafter also referred to as an “Lch audio signal”) and an audio signal picked up by the Rch microphone MIC-R (hereinafter also referred to as an “Rch audio signal”) are amplified by an Lch microphone amplifier 2L and an Rch microphone amplifier 2R, respectively, and are converted into digital signals by analog-to-digital (A/D) converters 3L and 3R, respectively. The resulting digital signals are then supplied to an audio signal processor 4 through an Lch input changeover switch SW-L1 and an Rch input changeover switch SW-R1.

The Lch input changeover switch SW-L1 and the Rch input changeover switch SW-R1 are described below.

In the following description, an Lch audio signal and Rch audio signal that are input to the audio signal processor 4 serving as a signal processing apparatus of an embodiment of the present invention (including audio signal processors 30, 35, 40, 46, 51, 60, and 65 described below) are referred to as an “audio signal Lin” and an “audio signal Rin”, respectively.

The audio signal processor 4 applies desired audio signal processing to the input audio signals Lin and Rin, and outputs the results as an Lch output audio signal Lex (also referred to simply as an “audio signal Lex”) and an Rch output audio signal Rex (also referred to simply as an “audio signal Rex”).

Particularly in the first embodiment, the audio signal processing performed by the audio signal processor 4 (30, 35, 40, 46, 51, 60, or 65) includes a process of reducing a predetermined signal component to suppress wind noise. The details of the reduction process are described below.

The audio signals Lex and Rex output from the audio signal processor 4 (30, 35, 40, 46, 51, 60, or 65) are supplied to the encoder 8 via an Lch output changeover switch SW-L2 and an Rch output changeover switch SW-R2, respectively.

The audio signals Lex and Rex can be output to digital-to-analog (D/A) converters 17L and 17R through the Lch output changeover switch SW-L2 and the Rch output changeover switch SW-R2, respectively. The switching operation of the Lch output changeover switch SW-L2 and the Rch output changeover switch SW-R2 is described below.

The encoder 8 receives the video signal from the video signal processor 7 and the audio signals Lex and Rex, and compression-encodes the received signals using a predetermined video/audio compression encoding method such as MPEG-2 (Moving Pictures Experts Group-2) before outputting them.

The compression-encoded video and audio signals are supplied to and recorded in a hard disc drive (HDD) 9 via a bus 11.

A system controller 10 is composed of a microcomputer including a read only memory (ROM), a random access memory (RAM), a central processing unit (CPU), etc., and is configured to control the overall operation of the video camera system 1. The system controller 10 is operable to exchange various commands and data with the encoder 8, the HDD 9, and a decoder 15 and external communication interface 16 described below through the bus 11.

The system controller 10 is adapted to control the transfer of the video and audio signals recorded in the HDD 9 to an external device. Specifically, the system controller 10 controls the reading and writing operations from and to the HDD 9 connected through the bus 11, and controls the external communication interface 16 to control the transfer of the video and audio signals to and from an external device (such as a personal computer, a digital versatile disk (DVD) recorder, or an HDD recorder) connected through an interface terminal T-INT. More specifically, for example, when the video and audio signals are transferred from the HDD 9 to the external device, the system controller 10 controls the reading of the video and audio signals from the HDD 9, and instructs the external communication interface 16 to transfer the read signals so that the read signals are transferred to the external device from the external communication interface 16 via the interface terminal T-INT.

The system controller 10 is further operable to supply display data such as various characters and icons to the display processor 13 to display desired information on the display unit 14.

Particularly in the first embodiment, the system controller 10 is adapted to supply various parameters for the reduction process to the audio signal processor 4 (30, 35, 40, 46, 51, 60, or 65), as indicated by a control signal CNT, which is described below.

An operation unit 12 is provided for the system controller 10. The operation unit 12 includes various handlers that are mounted so as to be exposed outside a housing of the video camera system 1, and command signals corresponding to the operations of the handlers are supplied to the system controller 10.

The system controller 10 is configured to execute various control operations corresponding to the command signals from the operation unit 12. Thus, the video camera system 1 is configured to perform an operation corresponding to an operation input given by a user.

Examples of handlers mounted on the operation unit 12 include recording start/stop buttons and reproduction start/stop buttons.

In response to a recording start instruction given by the recording start button, the system controller 10 controls the recording of the video and audio signals obtained by the encoder 8 to the HDD 9. In response to a reproduction start instruction given by the reproduction start button, the system controller 10 controls the reading of the video and audio signals from the HDD 9.

The video and audio signals read from the HDD 9 under the control of the system controller 10 in the manner described above are supplied to the decoder 15 for compression-code decoding to reproduce the original video signal, Lch audio signal, Rch audio signal. The video signal is supplied to the video signal processor 7 in the manner shown in FIG. 1.

In the reproduction process, the system controller 10 controls the video signal processor 7 to supply the video signal input from the decoder 15 to the display processor 13, and controls the display unit 14 to display a reproduced image.

The Lch and Rch audio signals reproduced in the manner described above are supplied to the Lch input changeover switch SW-L1 and Rch input changeover switch SW-R1, respectively.

Each of the Lch input changeover switch SW-L1 and Rch input changeover switch SW-R1 is a two-contact switch that is switchable between a terminal t1 and a terminal t2 or t3. The terminals t1 of the Lch input changeover switch SW-L1 and Rch input changeover switch SW-R1 are connected to the audio signal processor 4 so that an audio signal to be input to the audio signal processor 4 can be changed. Specifically, the Lch and Rch audio signals from the decoder 15 are supplied to the terminals t3 while the Lch audio signal from the A/D converter 3L and the Rch audio signal from the A/D converter 3R are supplied to the terminals t2. Therefore, one of a picked-up audio signal and a reproduced signal is selectable as an audio signal to be input to the audio signal processor 4.

Although not shown in FIG. 1, the switching between the terminals of each of the Lch input changeover switch SW-L1 and Rch input changeover switch SW-R1 is controlled by the system controller 10. In the recording process, the system controller 10 causes the Lch input changeover switch SW-L1 and the Rch input changeover switch SW-R1 to select the terminals t2 to supply the picked-up audio signals to the audio signal processor 4. In the reproduction process, the system controller 10 causes the Lch input changeover switch SW-L1 and the Rch input changeover switch SW-R1 to select the terminals t3 to supply the reproduced signals to the audio signal processor 4.

In the first embodiment, the noise reduction process is performed in real time in the recording process. In the reproduction process, therefore, the system controller 10 uses the control signal CNT to specify a processing parameter so that the audio signal processor 4 may not perform the reduction process.

The system controller 10 also controls the switching between the terminals of each of the Lch output changeover switch SW-L2 and Rch output changeover switch SW-R2 to control the outputting of the audio signals Lex and Rex from the audio signal processor 4. Each of the Lch output changeover switch SW-L2 and Rch output changeover switch SW-R2 is also a two-contact switch that is switchable between a terminal t1 and a terminal t2 or t3. Since the terminals t1 of the Lch output changeover switch SW-L2 and the Rch output changeover switch SW-R2 are connected to the audio signal processor 4, an audio signal to be output from the audio signal processor 4 can be switched between the audio signals Lex and Rex. Specifically, the terminals t2 of the Lch output changeover switch SW-L2 and Rch output changeover switch SW-R2 are connected to the encoder 8, and the terminals t3 are connected to the D/A converters 17L and 17R.

The audio signals Lex and Rex supplied to the D/A converters 17L and 17R are amplified by amplifiers 18L and 18R, respectively, and are then output as sound via speakers SP-L and SP-R, respectively.

With the above configuration, it can be controlled whether an audio signal is to be output as sound from the speakers SP or is to be output to the encoder 8 according to the control of the switching between the terminals of the Lch output changeover switch SW-L2 and Rch output changeover switch SW-R2.

In the recording process, the system controller 10 causes the Lch output changeover switch SW-L2 and the Rch output changeover switch SW-R2 to select the terminals t2 to supply the audio signals Lex and Rex to the encoder 8. In the reproduction process, on the other hand, the system controller 10 causes the Lch output changeover switch SW-L2 and the Rch output changeover switch SW-R2 to select the terminals t3 to supply the audio signals Lex and Rex via the speakers SP-L and SP-R, respectively.

Accordingly, in the recording process, a picked-up audio signal from the microphone MIC is processed by the audio signal processor 4, and is then recorded in the HDD 9 through the encoder 8. In the reproduction process, a reproduced image is displayed on the display unit 14, and reproduced sound is output via the speakers SP.

In FIG. 1, the video camera system 1 is adapted to record video and audio signals in an HDD by way of example. Alternatively, the video camera system 1 may be provided with a drive compatible with a removable medium such as an optical disk recording medium, e.g., a DVD or a Blu-ray Disc (BD), or a memory card.

The video camera system 1 with the above-described configuration includes a microphone and is configured to pick up and record external sound. As described above, when external sound is picked up using the microphone, turbulent airflow over a microphone unit causes noise called wind noise. The wind noise has a frequency component that is predominantly in a low-frequency range of about 1 kHz or less, and is noise such as buzz and hum.

One technique of the related art for reducing such wind noise is described in, for example, Japanese Patent No. 3186892 as noted above. However, this technique has a problem in that a low-frequency component of an audio signal to be picked up may also be attenuated while wind noise can be suppressed, leading to an unwanted significant change in timbre and difficulty with listening to, for example, a voice.

In the first embodiment, a technique that allows only wind noise to be suppressed without impairing the sound quality of an audio signal to be picked up is proposed. To this end, first, a wind noise reduction technique based on the following viewpoints is proposed in the first embodiment.

For example, in a case where sound is picked up using a stereo microphone or the like, generally, an audio signal to be picked up, such as a speaker's voice, is concentrated in the center and an unwanted signal component such as ambient sounds and noise is dispersedly localized in end areas, which are non-center areas. In light of this situation and the feature of wind noise described above (i.e., the main component of 1 kHz or less), a signal component that has a frequency less than or equal to a predetermined frequency and that is localized outside a certain localized (localization position) is reduced, whereby only a wind noise component can be suppressed without impairing the sound quality of an audio signal to be picked up.

The signal processing apparatus of the first embodiment performs a wind noise reduction process based on this concept.

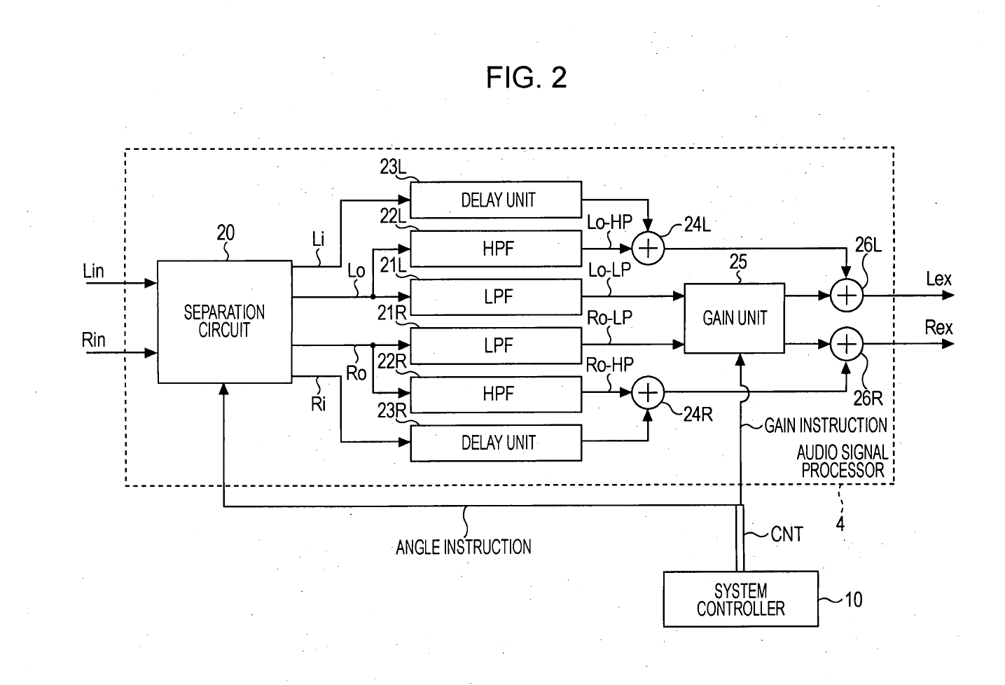

FIG. 2 shows a first example structure (hereinafter referred to as a “first example) of the audio signal processor 4 having shown in FIG. 1.

Referring to FIG. 2, the audio signal processor 4 of the first example includes a separation circuit 20, low pass filters (LPFs) 21L and 21R, HPFs 22L and 22R, delay units 23L and 23R, adders 24L and 24R, a gain unit 25, and adders 26L and 26R.

FIG. 2 also shows the system controller 10 shown in FIG. 1. In the first embodiment, an angle instruction signal and a gain instruction signal are supplied by the control signal CNT from the system controller 10. The angle instruction signal from the system controller 10 is supplied to the separation circuit 20 and the gain instruction signal is supplied to the gain unit 25 in the manner shown in FIG. 2.

The separation circuit 20 receives the audio signals Lin and Rin, and separates them into an audio signal of a sound source that is localized within a localization angle specified by the angle instruction signal (i.e., a sound source localized near the center) and an audio signal of a sound source that is localized outside the specified localization angle (i.e., a sound source localized near the end areas, which are non-center areas).

A technique for extracting a sound source localized within/outside a desired localization angle may be any of various existing techniques such as a vocal extraction/cancellation technique or a technique for extracting a center signal in a surround sound system, and is not to be limited to a specific technique.

For instance, the following technique may be adopted by way of example. The audio signals Lin and Rin are subjected to frequency analysis using a fast Fourier transform (FFT) or the like, and a level ratio or phase difference between an Lch-side signal and an Rch-side signal is determined for each frequency band having a desired width on the basis of the result of the frequency analysis. On the basis of this result, a localization angle for each frequency band is determined. Then, a target frequency characteristic that allows the extraction of only a signal component of a frequency band that is localized outside the specified angle is determined from information about the localization angles determined for the respective bands, and an equalization filter such as a finite impulse response (FIR) filter in which the determined frequency characteristic is set as a target characteristic is used to equalize waveforms of the audio signals Lin and Rin. With this technique, a signal component that is localized outside the specified angle can be extracted. A signal component that is localized within the specified angle may be determined by subtracting the extracted signal component outside the specified angle from the audio signals Lin and Rin, or by performing waveform equalization using a technique similar to that described above.

The separation circuit 20 supplies an Lch signal component Lo that is localized outside the specified angle, which is obtained by, for example, the separation processing described above, to the LPF 21L and the HPF 22L. The separation circuit 20 further supplies an Lch signal component Li that is localized within the specified angle to the delay unit 23L.

The separation circuit 20 also supplies an Rch signal component Ro that is localized outside the specified angle, which is obtained by the separation processing, to the LPF 21R and the HPF 22R, and supplies an Rch signal component Ri that is localized within the specified angle to the delay unit 23R.

In light of the feature of wind noise described above, each of the LPFs 21 and the HPFs 22 has a cutoff frequency of 1 kHz. In other words, the LPFs 21L and 21R are configured such that only components of 1 kHz or less are extracted from the Lch and Rch signal components Lo and Ro localized outside the individually specified angles, respectively. The HPFs 22L and 22R are configured such that only components with a frequency higher than 1 kHz are extracted from the Lch and Rch signal components Lo and Ro localized outside the individually specified angles, respectively.

The component of 1 kHz or less extracted by the LPF 21L from the Lch signal component Lo (hereinafter referred to as an “Lch low-pass output signal Lo-LP”), and the component of 1 kHz or less extracted by the LPF 21R from the Rch signal component Ro (hereinafter referred to as an “Rch low-pass output signal Ro-LP”) are supplied to the gain unit 25.

The gain unit 25 multiplies the supplied Lch and Rch low-pass output signals Lo-LP and Ro-LP by a gain specified by the gain instruction signal supplied from the system controller 10.

Depending on the gain instruction signal supplied from the system controller 10, a gain less than 1 may be specified. This may reduce the Lch low-pass output signal Lo-LP (i.e., the component of 1 kHz or less in the Lch signal component Lo localized outside the specified angle) and the Rch low-pass output signal Ro-LP (the component of 1 kHz or less in the Rch signal component Ro localized outside the specified angle), which are then output from the gain unit 25.

The reduced Lch low-pass output signal Lo-LP is supplied to the adder 26L, and the reduced Rch low-pass output signal Ro-LP is supplied to the adder 26R.

The signal component with a frequency higher than 1 kHz extracted by the HPF 22L from the Lch signal component Lo (hereinafter referred to as an “Lch high-pass output signal Lo-HP”) is supplied to the adder 24L, and is added to the Lch signal component Li (the Lch signal component within the specified angle) obtained through the delay unit 23L. The result is supplied to the adder 26L.

Likewise, the signal component with a frequency higher than 1 kHz extracted by the HPF 22R from the Rch signal component Ro (hereinafter referred to as an “Rch high-pass output signal Ro-HP”) is supplied to the adder 24R, and is added to the Rch signal component Ri (the Rch signal component within the specified angle) obtained through the delay unit 23R. The result is supplied to the adder 26R.

The delay units 23L and 23R are designed to output the Lch and Rch signal components Li and Ri with delays of the same periods of time as those of processing delays that occur in the HPFs 22 and the LPFs 21, respectively.

The adder 26L adds the reduced signal of the Lch low-pass output signal Lo-LP, which is obtained by the gain unit 25, to the sum output signal obtained the adder 24L, and outputs the result. The adder 26R adds the reduced signal of the Rch low-pass output signal Ro-LP, which is obtained by the gain unit 25, to the sum output signal obtained by the adder 24R, and outputs the result.

The sum results are output from the audio signal processor 4 as the audio signals Lex and Rex, which are also shown in FIG. 1.

In the first embodiment, therefore, after the Lch and Rch signal components Lo and Ro localized outside the specified angles are extracted, components that have a frequency less than or equal to a predetermined frequency (in this case, components of 1 kHz or less) in the Lch and Rch signal components Lo and Ro are reduced. This can prevent the occurrence of a situation where, for example, even an audio signal component to be picked up, which is localized near the center, is reduced, which is caused by, for example, an existing method of merely extracting and reducing only a low-frequency component. As a consequence, only a wind noise component can be suppressed without impairing the sound quality of an audio signal to be picked up.

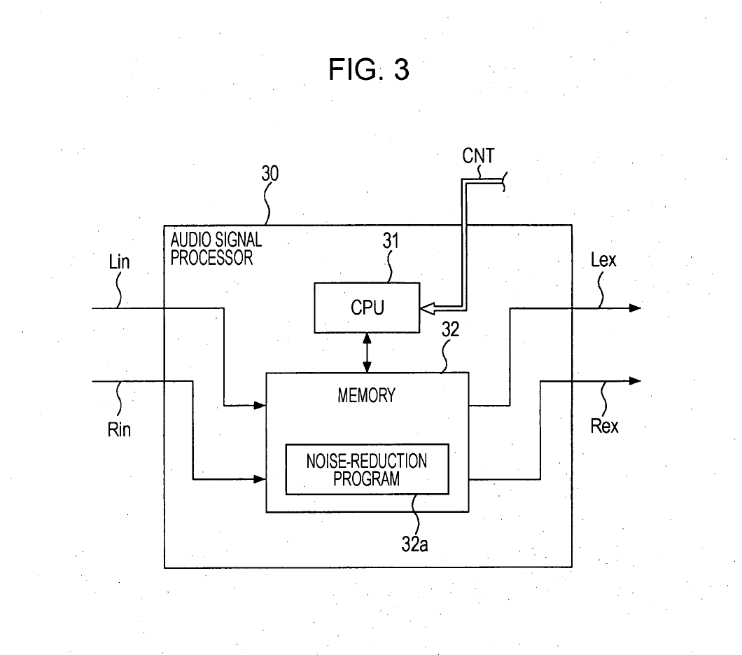

In the foregoing description, the reduction process according to the first example of the first embodiment is implemented by a hardware configuration, by way of example. For example, as shown in FIG. 3, an audio signal processor 30 including a CPU 31 and a memory 32 may be provided, thereby implementing the reduction process by software processing (hereinafter referred to as a “second example”). The audio signal processor 30 according to the second example will now be described.

In FIG. 3, also in this case, the audio signals Lin and Rin are supplied to the audio signal processor 30. The audio: signal processor 30 is configured such that the audio signals Lin and Rin are buffered in the memory 32 under control of the CPU 31.

The audio signal processor 30 is further configured such that the audio signals Lin and Rin buffered in the memory 32 are output as the audio signals Lex and Rex, respectively, to the outside of the audio signal processor 30 under the control of the CPU 31.

The memory 32 represents an entire memory provided in the CPU 31. Particularly in the second example, a noise-reduction program 32a used for implementing the reduction process according to the first example by software processing is stored in the memory 32.

In the second example, the control signal CNT from the system controller 10 is supplied to the CPU 31, and an angle instruction and a gain instruction is sent to the CPU 31.

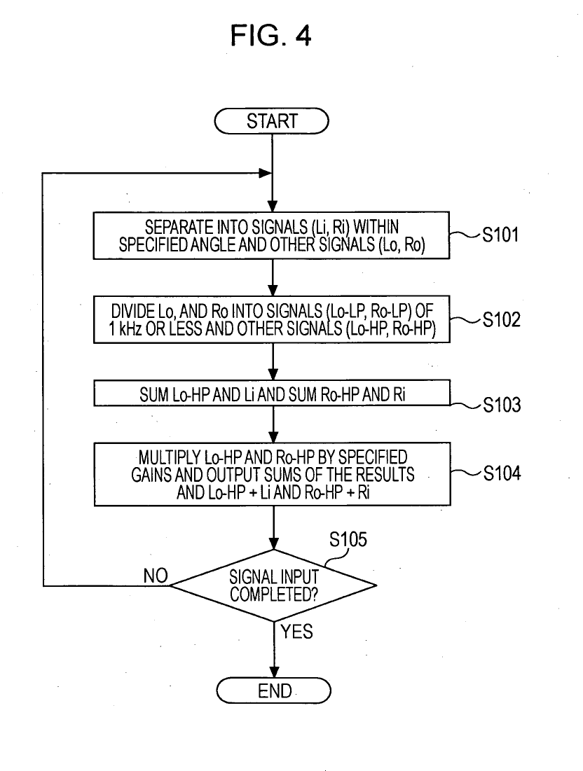

FIG. 4 is a flowchart showing a processing operation to be performed by the CPU 31 to implement the reduction process according to the first example with the configuration shown in FIG. 3. The processing operation shown in FIG. 4 is executed by the CPU 31 according to the noise-reduction program 32a.

Although not specifically referred to in the foregoing description, in the noise reduction process of the first embodiment, an input audio signal is segmented into predetermined time units (frame units), and processing steps are sequentially performed for each of the time units. In other words, as shown in FIG. 4, a set of processing steps from the extraction of a wind noise component up to the reduction of the wind noise component is repeatedly performed for every frame unit.

Referring to FIG. 4, first, in step S101, the audio signals Lin and Rin are separated into signals within a specified angle and other signals. Specifically, based on information about specified localization angles sent from the system controller 10, the audio signal Lin is separated into the Lch signal component Li localized within the specified angle and the Lch signal component Lo localized outside the specified angle, and the audio signal Rin is separated into the Rch signal component Ri localized within the specified angle and the Rch signal component Ro localized outside the specified angle.

In step S102, each of the Lch signal component Lo and Rch signal component Ro is separated into a signal with 1 kHz or less and other signals. Specifically, the Lch signal component Lo is separated into the low-pass output signal Lo-LP with 1 kHz or less and the remaining high-pass output signal Lo-HP, and the Rch signal component Ro is separated into the Rch low-pass output signal Ro-LP with 1 kHz or less and the remaining Rch high-pass output signal Ro-HP.

In step S103, the Lch high-pass output signal Lo-HP and the Lch signal component Li are summed, and the Rch high-pass output signal Ro-HP and the Rch signal component Ri are summed.

In step S104, the Lch low-pass output signal Lo-LP and the Rch low-pass output signal Ro-LP are multiplied by the individually specified gains from the system controller 10, and the results are added to the signals Lo-HP+Li and Ro-HP+Ri determined in step S103.

In step S105, it is determined whether or not the signal input is completed. Specifically, for example, the recording of a picked-up audio signal is stopped according to a recording stop instruction or the like, and it is determined whether or not the inputting of the audio signals Lin and Rin to the audio signal processor 30 is stopped. If a negative result indicating that the signal input is not stopped (terminated) is obtained, the process returns to step S101. If a positive result is obtained, the process shown in FIG. 4 ends.

In FIG. 4, by way of example, the signals Lo-HP+Li and Ro-HP+Ri are calculated in step S103, followed by the multiplication of the signals Lo-LP and Ro-LP by the specified gains in step S104. However, the order of operations may be reverse.

In the first example, each of the Lch signal component Lo and the Rch signal component Ro is separated into a component of 1 kHz or less (the signal component outside the specified angles) and other components using both the LPFs 21 and the HPFs 22. If the components of 1 kHz or less or the other components are successfully extracted, the remaining components might be determined by subtracting the extracted components from the original signal components. With this configuration, the LPFs 21 or the HPFs 22 can be omitted.

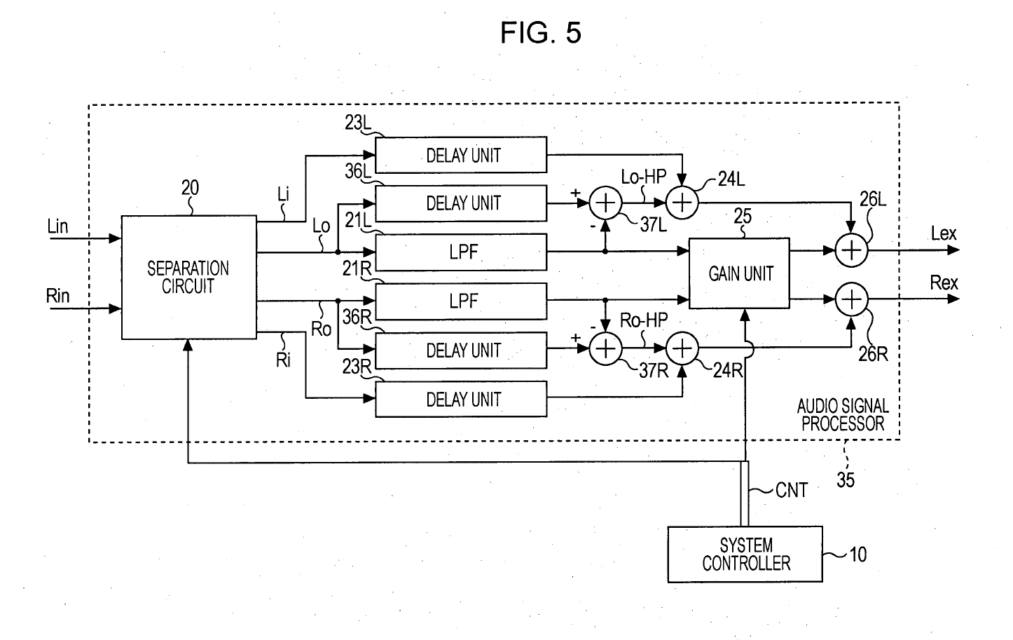

FIG. 5 shows an audio signal processor 35 with another example structure (hereinafter referred to as “a third example”) in which components of 1 kHz or less that are extracted using the LPFs 21L and 21R are subtracted from the original signal components to determine the remaining components. In FIG. 5, parts corresponding to the parts described above with reference to FIG. 2 are denoted by the same reference numerals and a description thereof is omitted.

In the audio signal processor 35, delay units 36L and 36R are provided in place of the HPFs 22L and 22R provided in the audio signal processor 4 shown in FIG. 2, respectively. Furthermore, as shown in FIG. 5, a subtractor 37L that subtracts the output of the LPF 21L from the output of the delay unit 36L is provided after the delay unit 36L, and a subtractor 37R that subtracts the output of the LPF 21R from the output of the delay unit 36R is provided after the delay unit 36R.

With the above configuration, the output of the subtractor 37L corresponds to the Lch low-pass output signal Lo-LP, and the output of the subtractor 37R corresponds to the Rch low-pass output signal Ro-LP. Therefore, as shown in FIG. 5, the output of the subtractor 37L is supplied to the adder 24L, and the output of the subtractor 37R is supplied to the adder 24R, whereby a result similar to that in the first example can be obtained.

It is noted that the delay units 36L and 36R are also configured to give delays of the same periods of time as those of processing delays that occur in the LPFs 21.

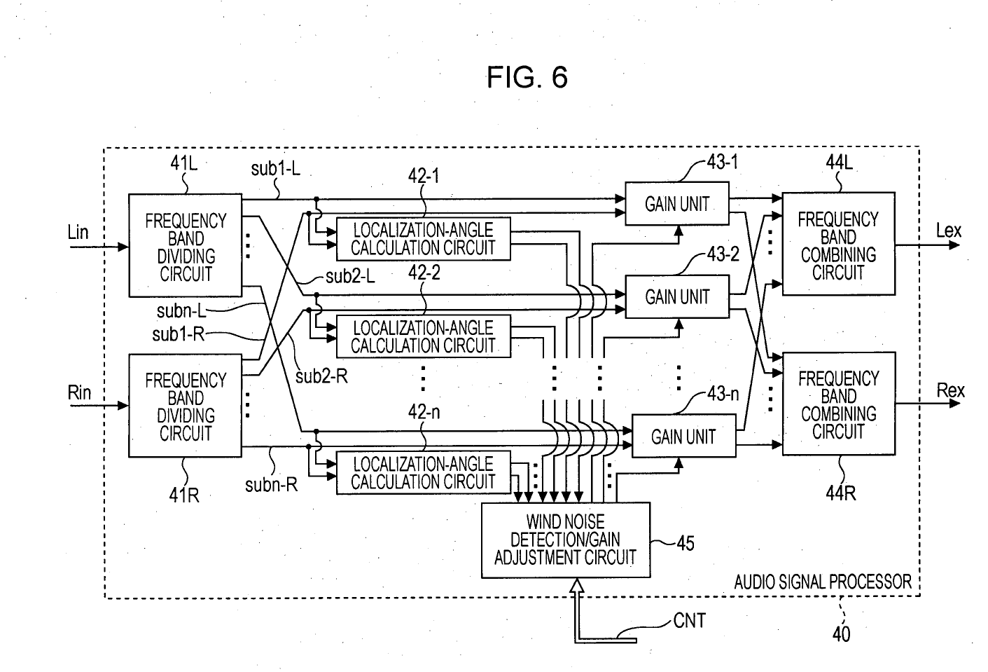

FIG. 6 is a block diagram showing an internal structure of a signal processing apparatus (an audio signal processor 40) according to a fourth example in the first embodiment. In FIG. 6, parts corresponding to the parts described above with reference to FIG. 2 are denoted by the same reference numerals and a description thereof is omitted.

The audio signal processor 40 according to the fourth example is configured to divide the audio signals Lin and Rin into a desired number of frequency bands, to perform a calculation based on each of Lch-side and Rch-side signals for each of the bands to determine a localization angle of a signal component in the corresponding band, to identify a signal component that is localized outside a specified angle (i.e., in non-center areas) from the result, and to multiply the identified signal component by a specified gain to reduce only wind noise.

In FIG. 6, the audio signal processor 40 includes a set of a frequency band dividing circuit 41L and a frequency band combining circuit 44L, and a set of a frequency band dividing circuit 41R and a frequency band combining circuit 44R to achieve a configuration in which, as described above, each of the audio signals Lin and Rin is divided into a desired number of frequency bands and in which signal components of the individual bands are finally integrated.

There are techniques called filter bank for dividing an input signal into a plurality of frequency bands, such as discrete Fourier transform (DFT), wavelet filter bank, and quadrature mirror filter (QMF) filter bank. A filter bank is composed of a set of a frequency band dividing process (analysis filter bank) and a frequency band combining process (synthesis filter bank). The filter bank technique is utilized to process an input signal for each band according to the purpose or the like, and is widely used for, for example, irreversible compression or the like.

While a filter bank technique is used for frequency band division by way of example, any other technique for division into a plurality of bands using a large number of band pass filters may be used.

The frequency band dividing circuit 41L divides the audio signal Lin into n frequency bands to obtain n Lch sub-band signals (sub1-L, sub2-L, . . . , and subn-L) from the audio signal Lin, and the frequency band dividing circuit 41R divides the audio signal Rin into n frequency bands to obtain n Rch sub-band signals (sub1-R to subn-R) from the audio signal Rin.

Each of the n Lch sub-band signals sub1-L to subn-L is supplied to the frequency band combining circuit 44L through a corresponding one of n gain units 43 (43-1 to 43-n), which is indicated by the corresponding subscript (one of 1 to n).

Each of the n Rch sub-band signals sub1-R to subn-R is also supplied to the frequency band combining circuit 44R through a corresponding one of the gain units 43-1 to 43-n, which is indicated by the corresponding subscript (one of 1 to n).

The frequency band combining circuit 44L combines the n Lch sub-band signals sub1-L to subn-L supplied from the gain units 43 into the original form (state) of audio signal, and outputs it as the audio signal Lex.

Likewise, the frequency band combining circuit 44R combines the n Rch sub-band signals sub1-R to subn-R supplied from the gain units 43 into the original form (state) of audio signal, and outputs it as the audio signal Rex.

When the frequency band dividing circuits 41L and 41R divide input audio signals into a plurality of bands, each of the bands may have an equal width or different widths from each other.

For example, in the first embodiment, for the purpose of reduction of wind noise, a frequency range higher than, for example, 1 kHz is not subjected to processing. Thus, for example, a frequency range of 1 kHz or less may be equally divided into 64 sub-bands, and the remaining frequency range may be integrated into a single frequency range.

What is to be noted here that the frequency band dividing circuits 41L and 41R perform frequency band division so as to divide a frequency range of 1 kHz or less into a plurality of bands. In other words, lack of such frequency band division for dividing a frequency range of 1 kHz or less into a plurality of bands might not provide appropriate separation into a wind noise component and other components.

Referring back to FIG. 6, the audio signal processor 40 of the fourth example further includes n localization-angle calculation circuits 42 (42-1 to 42-n) and a wind noise detection/gain adjustment circuit 45 to achieve a configuration in which a localization angle is determined for each frequency band and in which a sub-band signal sub that is localized outside an angle specified based on the determined localization angle is multiplied by a specified gain.

As shown in FIG. 6, the Lch sub-band signals sub1-L to subn-L generated by the frequency band dividing circuit 41L and the Rch sub-band signals sub1-R to subn-R generated by the frequency band dividing circuit 41R are supplied to the corresponding gain units 43, and are also branched and supplied to corresponding ones of the localization-angle calculation circuits 42-1 to 42-n, which are indicated by the corresponding subscripts. In other words, each of the localization-angle calculation circuits 42-1 to 42-n receives the Lch and Rch sub-band signals sub-L and sub-R of a corresponding one of the frequency bands.

Each of the localization-angle calculation circuits 42 performs a calculation based on the input Lch sub-band signal sub-L and Rch sub-band signal sub-R to determine a localization angle for a signal component of the corresponding frequency band, and supplies the result to the wind noise detection/gain adjustment circuit 45. Specifically, for example, the localization-angle calculation circuit 42-1 performs a calculation based on the Lch and Rch sub-band signals sub1-L and sub1-R to determine a localization angle for the corresponding band (band 1), and the localization-angle calculation circuit 42-2 performs a calculation based on the Lch and Rch sub-band signals sub2-L and sub2-R to determine a localization angle for band 2. Accordingly, a localization angle is determined from the Lch and Rch sub-band signals sub-L and sub-R for each frequency band, and the results are supplied to the wind noise detection/gain adjustment circuit 45.

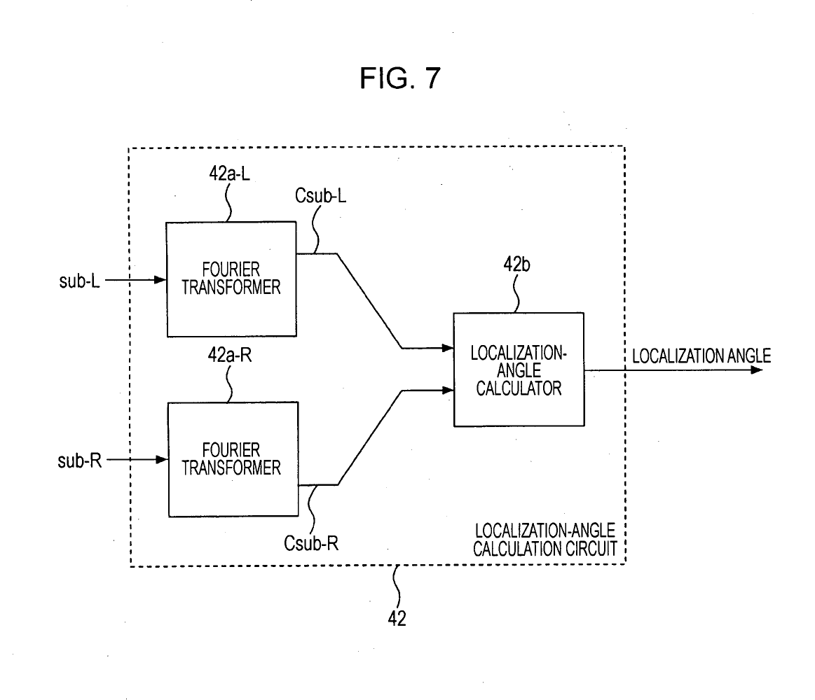

FIG. 7 shows an internal structure of each of the localization-angle calculation circuits 42.

As shown in FIG. 7, the localization-angle calculation circuit 42 includes an Lch Fourier transformer 42a-L, an Rch Fourier transformer 42a-R, and a localization-angle calculator 42b.

The Fourier transformers 42a-L and 42a-R apply Fourier transform processing such as an FFT to the Lch and Rch sub-band signals sub-L and sub-R, respectively. The Fourier transformers 42a-L and 42a-R perform the Fourier transform processing to obtain Lch and Rch complex sub-band signals Csub-L and Csub-R, respectively.

The Lch and Rch complex sub-band signals Csub-L and Csub-R are supplied to the localization-angle calculator 42b.

In the frequency band dividing circuits 41, if the sub-band signals sub have been converted into a complex sub-band form, the Fourier transformers 42a may be omitted, and the Lch sub-band signal sub-L and the Rch sub-band signal sub-R may be supplied directly to the localization-angle calculator 42b.

The localization-angle calculator 42b calculates a phase difference and level ratio between the Lch and Rch complex sub-band signals Csub-L and Csub-R, and determines a localization angle of a signal component of the corresponding frequency band from the calculated phase difference and level ratio. Information about the determined localization angles is supplied to the wind noise detection/gain adjustment circuit 45 shown in FIG. 6.

Referring back to FIG. 6, the wind noise detection/gain adjustment circuit 45 determines a gain for each of the gain units 43-1 to 43-n so that only wind noise can be reduced on the basis of the localization angle information for the respective frequency bands supplied from the localization-angle calculation circuits 42-1 to 42-n and the control signal CNT (the angle instruction signal and the gain instruction signal) from the system controller 10.

Specifically, first, a frequency band for which a localization angle is outside the angle specified by the angle instruction signal is identified from frequency bands of 1 kHz or less. Then, the gain specified by the gain instruction signal is determined to be the gain to be set for a corresponding one of the gain units 43-1 to 43-n that are associated with the identified frequency band (i.e., a gain unit 43 that is indicated by the corresponding subscript among the subscripts 1 to n). Meanwhile, a gain of 1 is determined to be the gain to be set for the gain units 43 associated with the other frequency bands. Then, the gains of the gain units 43 are adjusted so that the gain determined for each of the gain units 43 is set.

Also with the above processing, only a signal component that is localized outside a specified angle can be suppressed, and only wind noise can therefore be reduced.

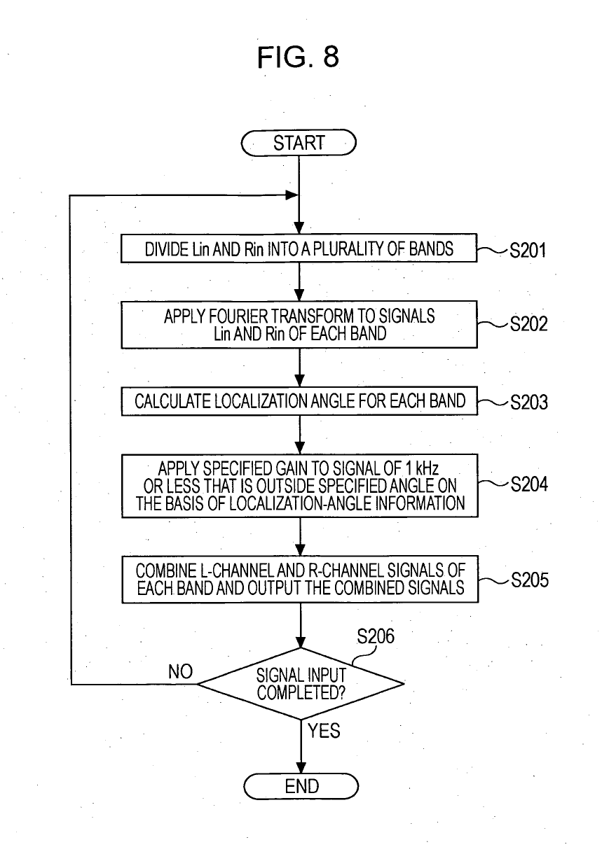

The reduction process according to the fourth example can also be implemented in software. FIG. 8 shows a processing-operation to be executed when the reduction process according to the fourth example is implemented by software processing.

The internal structure of an audio signal processor according to the fourth example that is operable to implement the reduction process in software is similar to that shown in FIG. 3, and a redundant description thereof is thus omitted.

The processing operation shown in FIG. 8 may also be executed by the CPU 31 shown in FIG. 3 according to the noise-reduction program 32a stored in the memory 32.

The same applies to implementations in software according to the following embodiments.

Referring to FIG. 8, first, in step S201, each of the audio signals Lin and Rin is divided into a plurality of bands. Specifically, the audio signals Lin and Rin are divided into one to n frequency bands to obtain Lch sub-band signals sub1-L to subn-L and Rch sub-band signals sub1-R to subn-R, respectively.

In step S202, a Fourier transform is applied to signals with each of the bands of the audio signals Lin and Rin. That is, a Fourier transform is applied to each of the Lch sub-band signals sub1-L to subn-L and the Rch sub-band signals sub1-R to subn-R obtained in the division processing of step S201 to obtain Lch complex sub-band signals Csub-L (Csub1-L to Csubn-L) and Rch complex sub-band signals Csub-R (Csub1-R to Csubn-R).

As described above, if the complex sub-band form is already obtained at the band division processing, no Fourier transform processing is performed. Thus, the processing of step S202 is skipped, and the process proceeds to step S203.

In step S203, a localization angle is determined for each band. Specifically, a phase difference and level ratio between each of the Lch complex sub-band signals Csub1-L to Csubn-L and a corresponding one of the Rch complex sub-band signals Csub1-R to Csubn-R, which is indicated by the corresponding subscript (one of 1 to n), are determined, and information about localization angles of signal components of the frequency bands (1 to n) is obtained on the basis of the results.

In step S204, the specified gain is given to a signal with a band of 1 kHz or less and that is outside the specified angle on the basis of the information about localization angles. That is, a signal (sub-band signal sub) that has a frequency band of 1 kHz or less and that is outside the angle specified by the system controller 10 is multiplied by a gain specified also by the system controller 10 on the basis of localization angle information for each frequency band.

As is to be understood from the foregoing description, a gain of 1 is given to a signal of a frequency band that is not a band of 1 kHz or less and that is outside the specified angle.

In step S205, the Lch and Rch signals for each band are combined and output. Specifically, the Lch sub-band signals sub1-L to subn-L and the Rch sub-band signals sub1-R to subn-R are multiplied by the corresponding gains, and are then combined and output as the audio signals Lex and Rex, respectively.

In step S206, as in the processing of step S105 shown in FIG. 4, it is determined whether or not the signal input is completed. If the signal input is not completed, the process returns to step S201. If the signal input is completed, the process ends.

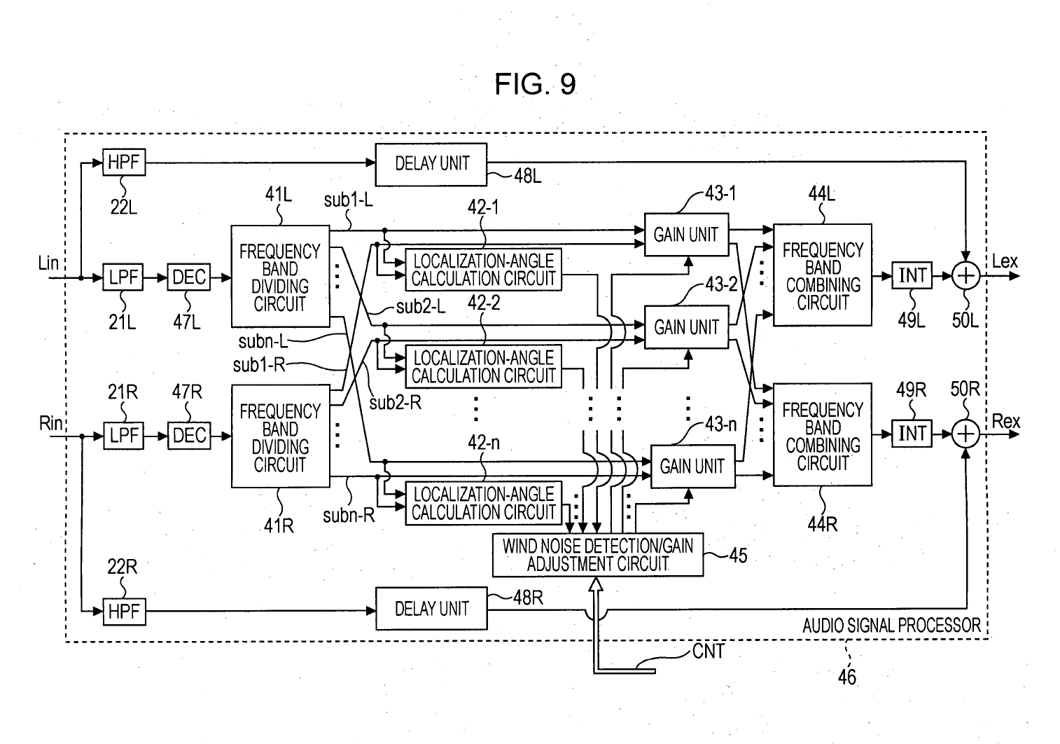

FIG. 9 is a block diagram showing an internal structure of a signal processing apparatus (audio signal processor 46) according to a fifth example in the first embodiment. In FIG. 9, parts similar to those in the foregoing example structures are denoted by the same reference numerals and a description thereof is omitted.

The audio signal processor 46 according to the fifth example is an improvement of the audio signal processor 40 according to the fourth example. Specifically, an audio signal that is down-sampled by a decimator (DEC) 47 is subjected to band division by the frequency band dividing circuit 41 to perform band division with a more detailed division width.

Referring to FIG. 9, in the audio signal processor 46, a set of an LPF 21L and an HPF 22L and a set of an LPF 21R and an HPF 22R, which are similar to those shown in FIG. 2, are provided for input audio signals Lin and Rin, respectively. The audio signal Lin (a signal component of 1 kHz or less) passing through the LPF 21L is supplied to a DEC 47L, and the audio signal Lin (a signal component with a frequency higher than 1 kHz) passing through the HPF 22L is input to an adder 50L described below through a delay unit 48L.

The audio signal Rin (a signal component of 1 kHz or less) passing through the LPF 21R is supplied to a DEC 47R, and the audio signal Rin (a signal component with a frequency higher than 1 kHz) passing through the HPF 22R is input to an adder 50L through a delay unit 48R.

Delay times of the delay units 48 are determined so that audio signals output from the delay units 48 and audio signals output from interpolators (INT) 49 described below are synchronous with each other.

The DECs 47L and 47R perform sampling-frequency conversion processing on the output signals of the LPFs 21L and 21R, respectively, to convert a sampling frequency to a lower frequency (that is, perform downsampling). In the first embodiment, since the reduction process is performed for a signal that has a frequency less than or equal to a predetermined frequency (specifically, 1 kHz or less), any frequency satisfying the sampling theorem, i.e., a frequency equal to or more than 2 kHz, may be used as the sampling frequency. The sampling frequency is converted into 8 kHz by way of example.

Such conversion of the sampling frequency can reduce the frequency bandwidth (width of the division bands) corresponding to a single sub-band in a process for division into n frequency bands using the frequency band dividing circuits 41L and 41R, and can improve the accuracy of noise reduction process correspondingly. For example, if it is assumed that the original sampling frequency is 48 kHz and an input audio signal is divided into 1024 equal sub-bands, the division bands typically have a width of about 47 Hz. In a case where, as described above, the sampling frequency is 8 kHz, on the other hand, the width of the division bands can be reduced to about 8 Hz.

It is to be noted that since only a signal component of 1 kHz or less is targeted by the LPFs 21 provided before the DECs 47, no aliasing affects the processing results of the frequency band dividing circuits 41.

The localization-angle calculation circuits 42, the wind noise detection/gain adjustment circuit 45, the gain units 43, and the frequency band combining circuits 44L and 44R, which are provided after the frequency band dividing circuits 41L and 41R, perform operations similar to those in the fourth example. In this case, the synthesis output of the frequency band combining circuit 44L is supplied to the INT 49L and the synthesis output of the frequency band combining circuit 44R is supplied to the INT 49R, where up-sampling processing is performed so as to return to the original sampling frequency (e.g., in the above example, 48 kHz). In other words, processing reverse to the sampling frequency conversion performed by the DECs 47L and 47R is performed.

The processing result obtained by the INT 49L is supplied to the adder 50L, and the processing result of the INT 49R is supplied to the adder 50R.

The adder 50L adds the processing result obtained by the INT 49L (the Lch signal component of 1 kHz or less in which the wind noise component has been reduced) to the output of the delay unit 48L (the Lch signal component with a frequency higher than 1 kHz), and outputs the result as an audio signal Lex. The adder 50R adds the processing result obtained by the INT 49R (the Rch signal component of 1 kHz or less in which the wind noise component has been reduced) to the output of the delay unit 48R (the Rch signal component with a frequency higher than 1 kHz), and outputs the result as an audio signal Rex.

Also with the structure of the fifth example, the audio signals Lex and Rex with wind noise reduced can be obtained.

In the fifth example, according to the foregoing description, if the sampling frequency is 2 kHz, band division can be performed in the most detailed manner in a case where it is assumed that wind noise whose main component is 1 kHz or less is reduced. Conversely, this means that a reduction in the down-sampling rate set in the DECs 47 might reduce a processing load. In other words, the lower the down-sampling rate set in the DECs 47, the larger the number of frequency bands higher than 1 kHz within the individual sub-bands tends to be. In the wind noise reduction process, the localization angle determination processing and the gain adjustment processing can be omitted for a frequency range higher than 1 kHz. With the tendency to increase the number of frequency bands of higher than 1 kHz, the omission of the processing can reduce a processing load.

Although not described with reference to the figures, the reduction process according to the fifth example can also be implemented in software. In this case, the processing operation shown in FIG. 8 may be modified as follows. In step S201, after the audio signals Lin and Rin are subjected to LPF processing and HPF processing with a cutoff frequency of 1 kHz, only portions of the audio signals Lin and Rin with 1 kHz or less are divided into a plurality of bands. In the subsequent processing of steps S202 to S204, a signal with each of the individual band obtained in step S201 may be subjected to processing similar to that described with reference to FIG. 8. In step S205, the Lch and Rch signals with each of the bands are combined, and the Lch and Rch combined results are further combined with the Lch and Rch signal components with a frequency higher than 1 kHz obtained in the HPF processing of step S201, respectively, which is then output.

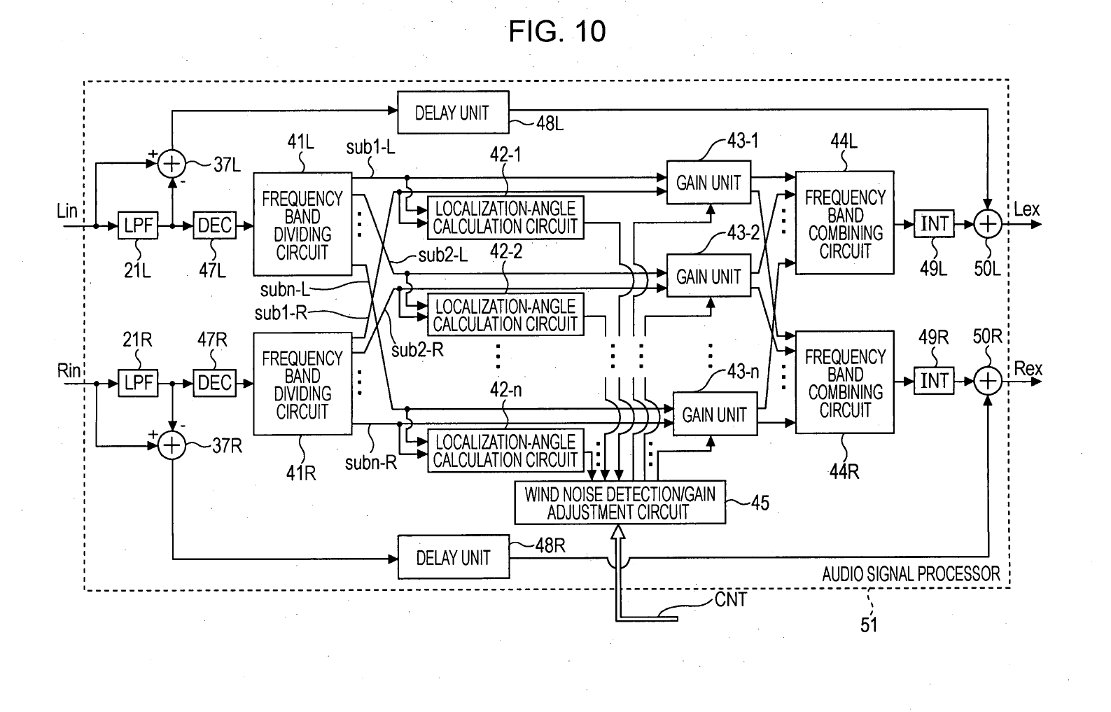

FIG. 10 is a block diagram showing an internal structure of a signal processing apparatus (audio signal processor 51) according to a sixth example in the first embodiment. In FIG. 10, parts similar to those of the foregoing-examples are denoted by the same reference numerals and a description thereof is omitted.

The audio signal processor 51 of the sixth example is configured such that the HPFs 22 are removed from the audio signal processor 46 of the fifth example using a technique similar to that of the third example.

As shown in FIG. 10, the HPFs 22L and 22R used in the fifth example are omitted. Instead, a subtractor 37L that receives the audio signal Lin and the output of the LPF 21L and that determines a difference therebetween, and a subtractor 37R that receives the audio signal Rin and the output of the LPF 21R and that determines a difference therebetween are provided. Therefore, a signal component of 1 kHz or less is subtracted from each of the audio signals Lin and Rin, and only a signal component with a frequency higher than 1 kHz is obtained.

The subtraction result of the subtractor 37L is supplied to the delay unit 48L, and the subtraction result of the subtractor 37R is supplied to the delay unit 48R.

### Second Embodiment

A second embodiment of the present invention will now be described.

In the first embodiment, the feature that target sound to be picked up such as voice tends to be localized near the center while non-target noise components tend to be localized near end areas is utilized to reduce a signal component of a sound source that has a frequency less than or equal to a predetermined frequency and that is localized out of the center to thereby suppress only wind noise. In the second embodiment, another feature of wind noise, namely, a feature that a wind noise component has a random signal waveform or a signal waveform that is uncorrelated between channels, is utilized to perform a reduction process to suppress only wind noise.

As described above, wind noise is caused by turbulent airflow over a microphone unit when sound is picked up. Because of this feature, a picked-up audio signal of wind noise has a feature of having a random or uncorrelated signal waveform in each channel. Such a random or uncorrelated signal waveform in each channel can mean that a wind noise component has a localization angle (localization position) that changes in a largely different manner from that of localization positions of other signal components along a time axis.

In the second embodiment, in view of the above feature, a signal component that has a frequency less than or equal to a predetermined frequency and that has a localization angle that changes in a manner different from a predetermined manner along a time axis is reduced to suppress only wind noise.

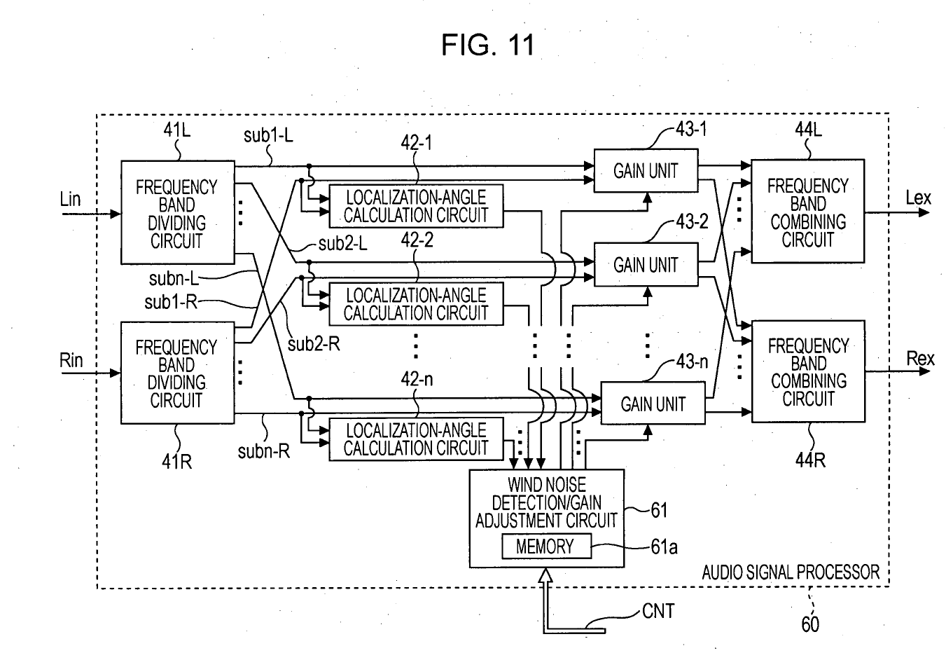

FIG. 11 is a block diagram showing an internal structure of a signal processing apparatus (audio signal processor 60) according to a second embodiment of the present invention. In FIG. 11, parts corresponding to the parts described previously are denoted by the same reference numerals and a description thereof is omitted.

In the audio signal processor 60, like the audio signal processor 40 of the fourth example (see FIG. 6) of the first embodiment, the audio signals Lin and Rin are subjected to band division processing by the frequency band dividing circuits 41L and 41R, respectively. A gain unit 43 is provided for each of individual sub-band signals sub. Outputs of the gain units 43 are combined channel by channel by the frequency band combining circuits 44L and 44R. The results are output as audio signals Lex and Rex. Also in the second embodiment, the sub-band signals sub obtained by the frequency band dividing circuits 41L and 41R are input to localization-angle calculation circuits 42 corresponding to the respective bands to obtain information about localization angles of signal components thereof for each band.

In the second embodiment, a wind noise detection/gain adjustment circuit 61 configured to receive the information about the localization angles for the respective bands and to adjust gains of the gain units 43 is provided.

The wind noise detection/gain adjustment circuit 61 includes an internal memory 61a that is configured to receive the information about the localization angles for the respective bands, which is determined for every predetermined processing time unit (every frame unit) by the localization-angle calculation circuits 42, and to store it on a band-by-band basis.

The wind noise detection/gain adjustment circuit 61 checks bands of 1 kHz or less to identify a band that has a localization angle changing in a different manner from a specified manner on the basis of the information about the localization angles stored in the memory 61a (localization angle information for a preceding frame: past localization angle information) and newly supplied information about localization angles (localization angle information for a current frame: current localization angle information). The gain of the gain unit 43 that is associated with the identified band is adjusted to a gain specified by the control signal CNT, and the gains of the other gain units 43 are adjusted to 1.

Specifically, instead of an angle instruction signal in the first embodiment, in the second embodiment, a reduced-threshold-value instruction signal is supplied to the wind noise detection/gain adjustment circuit 61 as the control signal CNT from the system controller 10.

The wind noise detection/gain adjustment circuit 61 further determines a difference value between a localization angle of a current frame and a localization angle of a preceding frame (i.e., an amount of shift between localization positions) for bands of 1 kHz or less, and identifies a band for which the difference value (amount of shift) is greater than a threshold value specified by the reduced-threshold-value instruction signal. The gain of the gain unit 43 that is associated with the identified band is adjusted (i.e., reduced) to a gain specified by the control signal CNT, and the gains of the other gain units 43 are adjusted to 1.

As described above, due to its random signal waveform or uncorrelated signal waveform between channels, a wind noise component has a localization angle (localization position) that also changes randomly in the time axis direction. The amount of shift between the localization positions in the time axis direction can therefore increase correspondingly. Thus, as described above, a band for which the amount of shift between the localization positions for components of 1 kHz or less in the time axis direction is greater than a specified value is detected, and a signal component of the detected band is reduced, whereby only a wind noise component can effectively be reduced.

In another point of view, the technique according to the second embodiment described above may also allow a reduction of a signal component of a portion having a low correlation of a localization angle in the time axis direction. The determination of a given band as to whether or not the signal component of the given band has a localization angle changing in a specified manner in the time axis direction can be equivalent to the determination as to whether the correlation of a localization angle of the signal component of the given band in the time axis direction high or low.

Specifically, a large amount of shift between localization positions in the time axis direction results from non-correlation of a localization angle of the wind noise component in the time axis direction. Therefore, the determination as to whether an amount of shift between localization positions for a signal component of a given band (i.e., the manner in which a localization angle changes in the time axis direction) is larger or smaller than a specified value can also be equivalent to the determination as to whether the correlation of the localization angle of the signal component of the given band is higher or lower than a specified value in the time axis direction.

The reduction process according to the second embodiment can also be implemented in software.

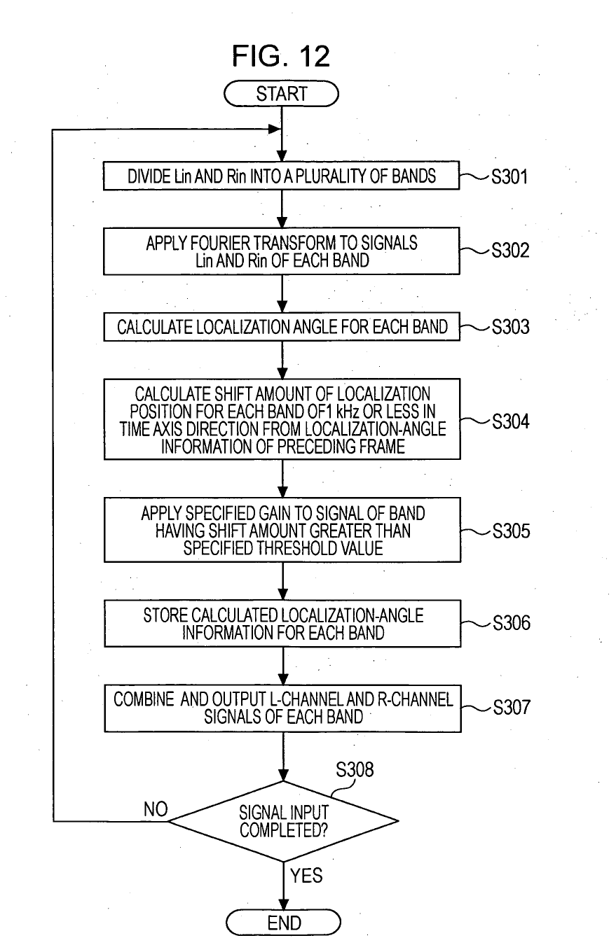

FIG. 12 shows a processing operation to be executed when the reduction process according to the second embodiment is implemented by software processing.

Referring to FIG. 12, first, band division processing of step S301, Fourier transform processing of step S302, and localization angle determination processing of step S303 are similar to those of steps S201, S202, and S203 described above with reference to FIG. 8, respectively.

In step S304, an amount of shift between localization positions in the time axis direction for each band of 1 kHz or less is determined on the basis of information about a localization angle of a preceding frame. Specifically, a difference value between a current frame and a preceding frame is calculated with respect to localization angles for the respective bands in the preceding frame, which are stored in step S306 described below, and localization angles for bands of 1 kHz or less among the localization angles for the respective bands (of the current frame), which are determined in step S303.

In step S305, a specified gain is given to a signal with a band for which the amount of shift is greater than a specified threshold value. Specifically, the difference value (amount of shift) for each band of 1 kHz or less, which is determined in step S304, is compared with a specified threshold value from the system controller 10, and a band for which the amount of shift is greater than the threshold value is identified. The signal component of the identified band is multiplied by the specified gain from the system controller 10, and the signal components of the other bands are multiplied by a gain of 1.

In step S306, information about the determined localization angles is stored on a band-by-band basis. That is, the information about localization angles determined in step S303 is stored in the memory 32 shown in FIG. 3 in association with the bands.

Further, in step S307, as in step S205 shown in FIG. 8, Lch and Rch signals with each band are combined and output. In step S308, as in step S206, it is determined whether or not the signal input is completed. If the signal input is not completed, the process returns to step S301. If the signal input is completed, the processing operation ends.

In the foregoing description, the determination of a wind noise component or not is based on only an amount of shift between localization positions by way of example. In the second embodiment, the determination of a wind noise component or not may be performed using any other technique for determining whether or not a localization angle changes in a specified manner in the time axis direction, in other words, determining whether the correlation of a localization angle in the time axis direction is high or low.

For example, a sound source to be picked up may be a sound source whose localization position changes with time so as to symmetrically oscillate about the center. In such a case, the determination based on only localization angle difference (amount of shift between localization positions) described above by way of example might also reduce a signal component of the sound source to be picked up.

Accordingly, for example, in order to support such a case, the determined localization angle value itself may be added to the criteria of determination of wind noise or not.

Specifically, for example, a difference in localization angle between a preceding frame and a current frame is compared with a specified threshold value, and a difference between the absolute value of the localization angle of the preceding frame and the absolute value of the localization angle of the current frame is also compared with a specifically set desired threshold value. If the difference in localization angle between the preceding frame and the current frame is smaller than the specified threshold value and if the difference between the absolute value of the localization angle of the preceding frame and the absolute value of the localization angle of the current frame is smaller than the desired threshold value, it is determined that the target is a sound source component to be picked up, and no reduction is performed. In other words, a component that does not satisfy the above condition is regarded as a wind noise component, and only that component is reduced.

With such a technique, by way of example, even in a case where a sound source to be picked up is symmetrically shifted about the center such as that described above, the sound source to be picked up can correctly be picked up, and only a wind noise component can be effectively reduced.

It is to be noted that the above technique also allows determination of “symmetric” correlation of a localization position of a sound source. For example, as described above, the determination of whether or not the difference between absolute values is greater than the desired threshold value is also equivalent to the determination as to whether the correlation is low or high.

In modifications of the second embodiment, the audio signal processor 60 of the second embodiment may be configured such that, for example, as described above with reference to FIG. 9, the LPFs 21, the HPFs 22, the DECs 47, the delay units 48, INTs 49, and the adders 50 are further provided. Alternatively, the HPFs 22 may be omitted. In this case, as described with reference to FIG. 10, the LPFs 21, the subtractors 37, the DECs 47, the delay units 48, the INTs 49, and the adders 50 may further be provided.

In the foregoing description, the manner in which localization angles change in the time axis direction is determined based on the relationship between a given frame and a frame one frame preceding the given frame by way of example. Instead, the determination as to whether or not a predetermined angle changes in the time axis direction in a different manner from a predetermined manner (the determination of whether the correlation is high or low) may be performed based on information about localization angles of a plurality of previous frames.

### Third Embodiment

In a third embodiment of the present invention, a signal component that has a frequency less than or equal to a predetermined frequency and for which a difference between a localization angle of the signal component and that of a frequency range adjacent thereto is greater than a specified value is reduced to suppress only wind noise.

The above-described feature of wind noise that signal waveform of each channel is random or uncorrelated can be equivalent to, in another point of view, a feature that a difference between a localization position of a wind noise component and that of a signal component of a frequency range adjacent to that of the wind noise component is significantly greater than that between remaining audio signal components. In the third embodiment, therefore, a signal component that has a frequency less than or equal to a predetermined frequency and for which a difference between a localization angle of the signal component and that of a frequency range adjacent to that of the signal component is greater than a specified value is reduced to thereby suppress only a wind noise component.

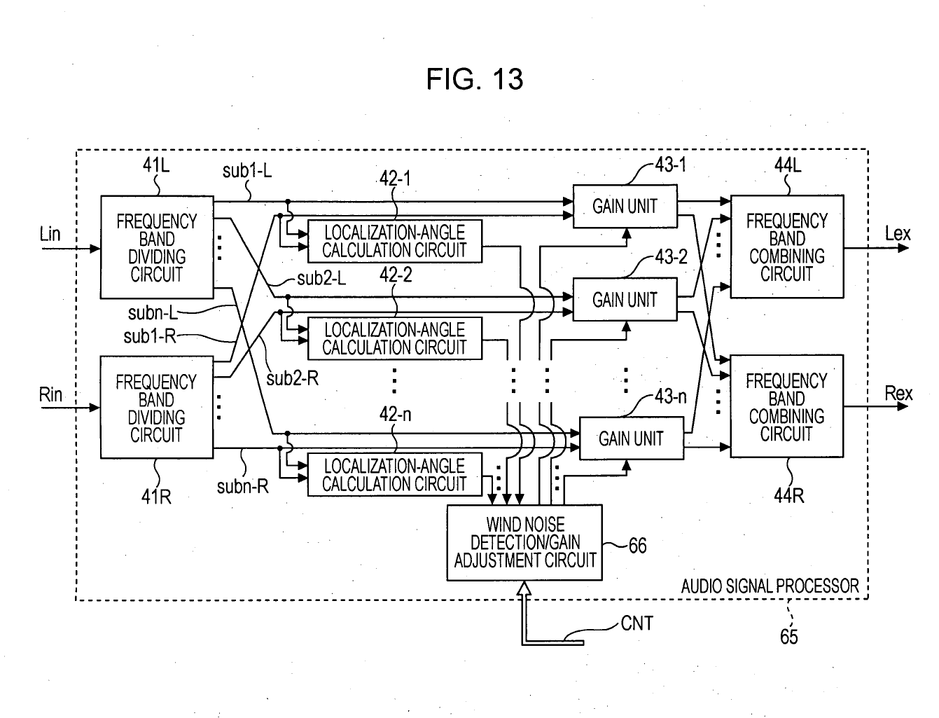

FIG. 13 is a block diagram showing an internal structure of a signal processing apparatus (audio signal processor 65) of the third embodiment. The audio signal processor 65 shown in FIG. 13 has a similar basic configuration to that of the audio signal processor 40 according to the fourth example (see FIG. 6) of the first embodiment and the audio signal processor 60 according to the second embodiment (see FIG. 11). In the third embodiment, however, a wind noise detection/gain adjustment circuit 66 according to the third embodiment is provided in place of the wind noise detection/gain adjustment circuit 45 (or 61).

A reduced-threshold-value instruction signal and a gain instruction signal are supplied to the wind noise detection/gain adjustment circuit 66 as a control signal CNT from the system controller 10. The reduced-threshold-value signal is different from that described above in the second embodiment, and specifies a threshold value used for determination based on a difference between a localization angle of a target signal component and that of an adjacent frequency range.

The wind noise detection/gain adjustment circuit 66 receives localization angle information for each band that is supplied from the localization-angle calculation circuits 42, and calculates a difference value between localization angle information for each band of 1 kHz or less and localization angle information for an adjacent frequency range to identify a band for which the difference value is greater than a value specified by the reduced-threshold-value instruction signal. For example, for ease of description, it is assumed that the localization angle information about the adjacent frequency range is a localization angle of an adjacent sub-band signal. In this case, a difference value between a localization angle of a target sub-band signal and that of an adjacent sub-band signal is calculated, and a band for which the difference value is greater than the threshold value is identified.

The gain of the gain unit 43 that is associated with the identified band is adjusted to a specified gain, and the gains of the other gain units 43 are adjusted to a gain of 1.

With the above-described operation performed by the wind noise detection/gain adjustment circuit 66, an audio signal from which only a wind noise component is reduced can be obtained as the audio signals Lex and Rex obtained by the combination processing by the frequency band combining circuits 44L and 44R, respectively, through the gain units 43.

In view of a concept similar to that of the second embodiment, a noise reduction technique according to the third embodiment can also be equivalent to the determination of the correlation of localization angles in the frequency axis direction. The reduction technique of the third embodiment therefore allows a signal component having a frequency less than or equal to a predetermined frequency and having a localization angle with a low correlation with an adjacent frequency range is reduced.

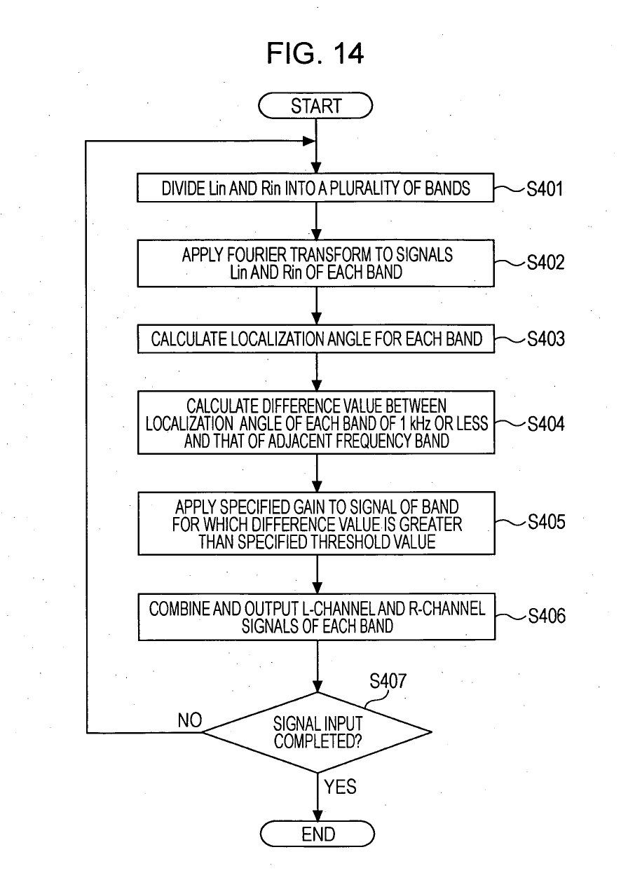

The reduction process of the third embodiment can also be implemented in software. FIG. 14 is a flowchart showing a processing operation to be performed according to the third embodiment.

Referring to FIG. 14, also in the third embodiment, band division processing of step S401, Fourier transform processing of step S402, and localization angle determination processing of step S403 are also similar to those of steps S201, S202, S203 described above with reference to FIG. 8, respectively.

In step S404, a difference value in localization angle between each band of 1 kHz or less and an adjacent frequency range is determined. That is, a difference value in localization angle between each band of 1 kHz or less and a single band adjacent thereto is calculated on the basis of the information about localization angles determined in step S403.

In step S405, a specified gain is given to a signal of a band for which the difference value is greater than a specified threshold value. That is, a difference value for each of bands of 1 kHz or less determined in step S404 is compared with a threshold value specified from the system controller 10, and a band for which the difference value is greater than the threshold value is identified. A signal component of the identified band is multiplied by a gain specified from the system controller 10, and signal components of the remaining bands are multiplied by a gain of 1.

Then, in step S406, as in step S205 shown in FIG. 8, Lch and Rch signals with each band are combined and output. In step S407, as in step S206, it is determined whether or not the signal input is completed. If the signal input is not completed, the process returns to step S401. If the signal input is completed, the processing operation ends.

In modifications of the third embodiment, as in the second embodiment, the audio signal processor 65 of the third embodiment may be configured such that, as described with reference to FIG. 9, the LPFs 21, the HPFs 22, the DECs 47, the delay units 48, the INTs 49, and the adders 50 are further provided. Alternatively, the HPF 22 shown in FIG. 9 may be omitted. In this case, as described with reference to FIG. 10, the LPFs 21, the subtractors 37, the DECs 47, the delay units 48, the INTs 49, and the adders 50 may further be provided.

In the foregoing description, for ease of illustration, a difference value between a localization angle of a target sub-band signal and that of a single sub-band signal adjacent thereto is determined by way of example. For example, a difference value between a localization angle of a target signal and that of a plurality of bands adjacent thereto such as ten bands may be determined. In this case, the localization angle for the plurality of adjacent bands may be obtained by averaging the localization angles for the bands.

### Modifications

While embodiments of the present invention have been described, the present invention is not to be limited to the foregoing embodiments. Modifications of the embodiments will be described hereinafter.

### First Modification

In a first modification, a volume level of wind noise is detected, and a noise reduction processing parameter is adjusted according to the detected level.

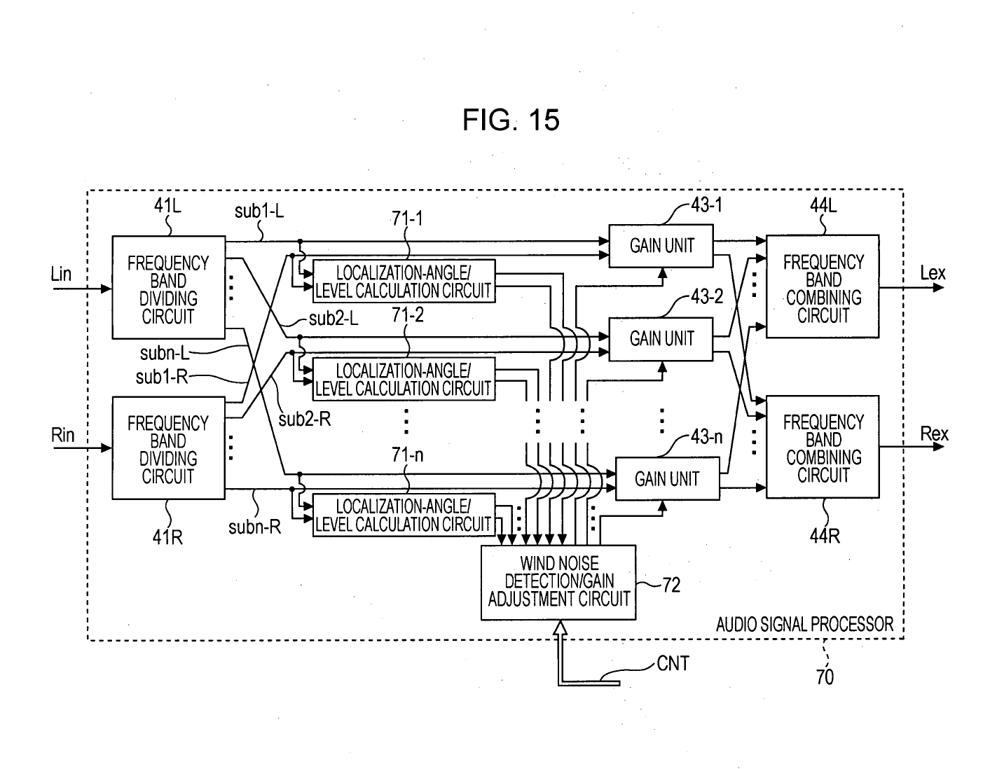

FIG. 15 shows an internal structure of a signal processing apparatus (audio signal processor 70) according to the first modification. In FIG. 15, parts corresponding to the parts described above are denoted by the same reference numerals and a description thereof is omitted. In FIG. 15, by way of example, an example structure employing the concept of the first modification, which is common to that of the audio signal processor 40 according to the fourth example (see FIG. 6) of the first embodiment, the audio signal processor 60 according to the second embodiment (see FIG. 11), and the audio signal processor 65 according to the third embodiment (see FIG. 13), is shown.

As shown in FIG. 15, the audio signal processor 70 of the first modification includes n localization-angle/level calculation circuits 71 (71-1 to 71-n) in place of the n localization-angle calculation circuits 42 provided in each of the audio signal processors (40, 60, and 65) shown in FIGS. 6, 11, and 13. The audio signal processor 70 further includes a wind noise detection/gain adjustment circuit 72 in place of the wind noise detection/gain adjustment circuits (45, 61, and 66) shown in FIGS. 6, 11, and 13. The wind noise detection/gain adjustment circuit 72 receives information about localization angles and volume levels for sub-bands, which is determined by the localization-angle/level calculation circuits 71-1 to 71-n, and performs gain adjustment of the gain units 43.

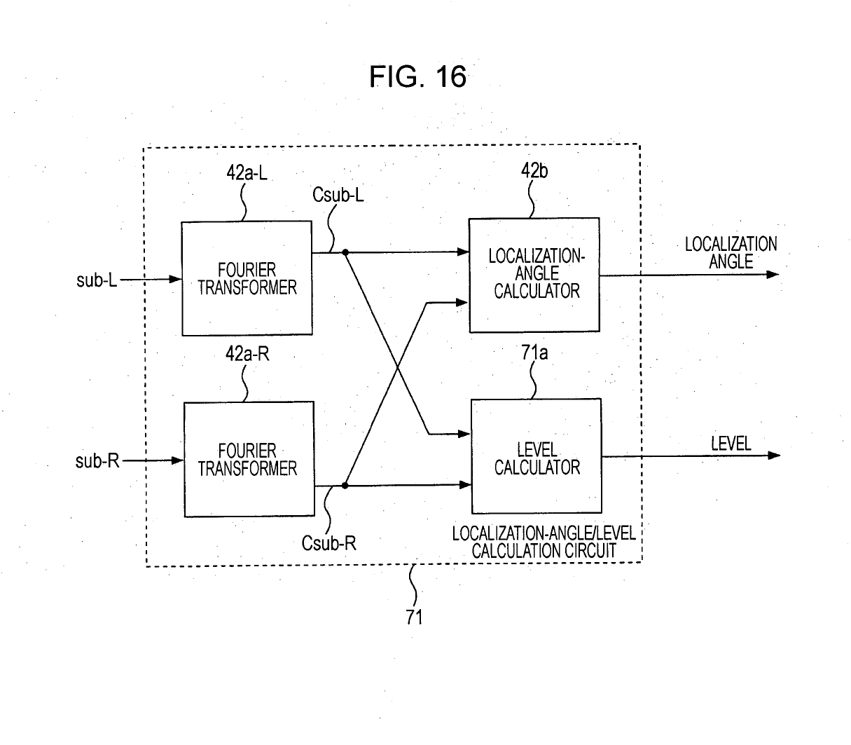

FIG. 16 shows an internal structure of each of the localization-angle/level calculation circuits 71. As is to be understood with reference to FIG. 16, the localization-angle/level calculation circuit 71 further includes a level calculator 71a in addition to the configuration of the localization-angle calculation circuit 42 shown in FIG. 7.

The level calculator 71a receives the Lch and Rch complex sub-band signals Csub-L and Csub-R obtained through the Lch and Rch Fourier transformers 42a-L and 42a-R, respectively, and performs calculation on the received signals to determine a magnitude of sound (volume level) of the corresponding sub-band signal component.

There may be several conceivable techniques for determining a volume level. One of such techniques is as follows. If the Lch and Rch complex sub-band signals Csub-L and Csub-R at time ω are denoted by L(ω) and R(ω), respectively, a volume level mag(ω) of the corresponding sub-band signal component at the time ω is given by Formula (1) as follows:

mag(ω)={square root over (Re(L(ω))²+Im(L(ω))²)}+{square root over (Re(R(ω))²+Im(R(ω))²)} (1)

where Re(x) denotes the real part of complex number x and Im(x) denotes the imaginary part of complex number x.

Referring back to FIG. 15, based on the information about volume levels determined by the localization-angle/level calculation circuits 71 in the manner described above, the wind noise detection/gain adjustment circuit 72 does not perform processing for noise reduction when a volume level is less than or equal to a predetermined threshold value, and performs processing for noise reduction only when a volume level is greater than the threshold value.

Specifically, first, the wind noise detection/gain adjustment circuit 72 determines a comprehensive volume level by, for example, averaging the volume levels of the respective sub-bands, and determines whether or not the comprehensive volume level is less than or equal to the threshold value. If the volume level is less than or equal to the threshold value, the gain of each of the gain units 43 is adjusted to 1. In other words, the gains are equally set to 1 without performing the operation of determining whether or not each sub-band is a wind noise component on the basis of the localization angle information supplied from the localization-angle/level calculation circuits 71.

If the volume level is greater than the threshold value, it is determined whether or not each sub-band of 1 kHz or less is a wind noise component in the manner described above with reference to the foregoing embodiments on the basis of localization angle information supplied from the localization-angle/level calculation circuits 71. When it is determined that a sub-band is a wind noise component, the gain of the gain unit 43 that is associated with the sub-band is adjusted to a specified gain, and the gains of the remaining gain units 43 are adjusted to 1.

As described above, the noise reduction operations of the individual sections are sequentially performed for every predetermined frame unit on a time axis. According to the operation of the first modification, time-consuming processing in a period during which there is no need for processing for noise reduction because of a small volume level can be omitted, and the processing can appropriately be performed only in a period during which there is a need for processing for noise reduction because of a large volume level.

In the first modification, a comprehensive volume level is determined from a volume level for each sub-band, and thereafter it is determined whether or not the reduction process based on a threshold value is performed, by way of example. Alternatively, it may be determined whether or not the reduction process is performed for every sub-band. In this case, the wind noise detection/gain adjustment circuit 72 determines whether or not a volume level is less than or equal to a specified threshold value for each sub-band, and adjusts the gain of the gain unit 43 that is associated with a sub-band whose volume level is less than or equal to the threshold value to 1 without determining whether or not the sub-band is a wind noise component on the basis of the localization angle information. For a sub-band whose volume level is greater than the threshold value, it is determined whether or not each band of 1 kHz or less is a wind noise component on the basis of the localization angle information. If it is determined that a band is a wind noise component, the gain of the gain unit 43 that is associated with the band is adjusted to a specified gain, and the gains of all the remaining gain units 43 are adjusted to 1.

As is to be understood from the foregoing description, in the second and third embodiments, the determination of a wind noise component or not involves a calculation. According to the above-described technique, there is no need for calculation processing for a sub-band whose volume level is less than or equal to a threshold value. Simple comparison and determination processing is merely performed, and a reduction in processing load can be effectively achieved correspondingly.

In the example structure shown in FIG. 15, a volume level is determined for every sub-band. For example, in a case where, as described above, a comprehensive volume level is used to determine whether or not the reduction process is performed, each of the localization-angle/level calculation circuits 71 may have a configuration similar to that of the localization-angle calculation circuit 42 shown in FIG. 7, and a circuit for determining a volume level from the audio signals Lin and Rin may further be provided so that the calculation results thereof are input to the wind noise detection/gain adjustment circuit 72.

As can also be understood from this description, a volume level may be determined using a time axis signal as well as from a complex sub-band signal as given by Formula (1).

While a signal processing apparatus is implemented in hardware using the first modification, the first modification may also be used for implementation in software. In a software implementation using the first modification, a process for determining a localization angle can be omitted for a sub-band having a volume level less than or equal to a threshold value. Thus, a further reduction in processing load can be achieved.

In the foregoing description, the first modification is applied to the fourth example of the first embodiment and the second and third embodiments. The first modification may also be applied to the example structures illustrated by way of example in the specification.

For instance, by way of example, the first modification may be applied to any example structure other than that of the fourth example in the first embodiment. In this case, however, a substantial reduction in processing load is not achieved even by applying the first modification to, for example, the hardware configuration shown in FIG. 2 or the like. It is therefore effective to use the first modification for implementation in software (e.g., the second example) (see FIG. 4). For example, in a case where the first modification is applied to the second example of the first embodiment, processing of receiving the audio signals Lin and Rin and determining a volume level, followed by processing of determining whether or not the volume level is less than or equal to a specified threshold value, is additionally performed before step S101 shown in FIG. 4. If it is determined in the determination processing that the volume level is less than or equal to the threshold value, the process skips steps S101 to S104, and proceeds to step S105 after the audio signals Lin and Rin are directly output (a gain of 1). If the determined volume level is greater than the threshold value, the process returns to step S101, and the following processing is performed.

With the application of the first modification to implementation in software in the manner described above, the audio signals Lin and Rin can be directly output when a volume level is less than or equal to a threshold value, and all processing involved in noise reduction can be omitted. Therefore, a greater processing load reduction effect can be obtained.

In the first modification, control between two determinations, i.e., whether or not to execute processing for noise reduction, is performed according to a volume level. In a further modification of the first modification, for example, a gain for noise reduction can be variably adjusted according to a volume level. Specifically, for example, if a volume level is greater than a specified threshold value, the value of a gain to be set for noise reduction is adjusted to a value ranging from a gain value specified from the system controller 10 to 1 in accordance with the determined volume level.

### Second Modification

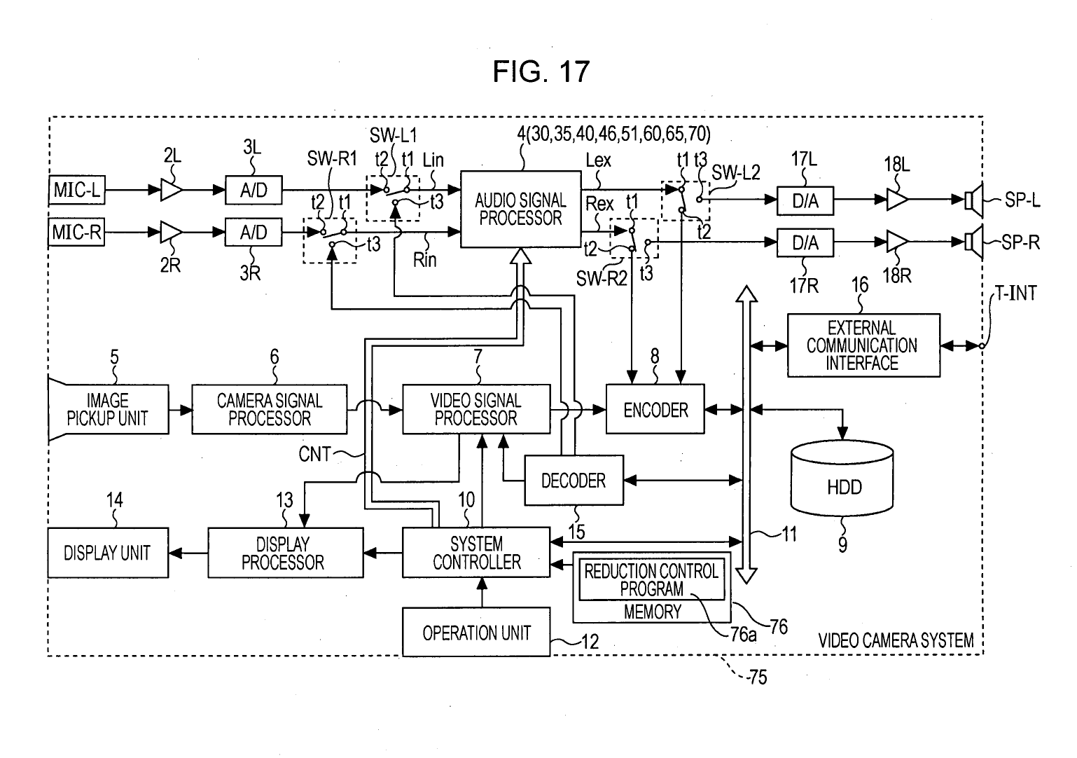

FIG. 17 shows an internal structure of a video camera system 75 according to a second modification.

In FIG. 17, parts corresponding to the parts described above with reference to FIG. 1 are denoted by the same reference numerals and a description thereof is omitted.

The video camera system 75 according to the second modification is configured such that a noise reduction process is performed during reproduction rather than recording. In the foregoing description, a noise reduction process is performed on a picked-up audio signal in real time, by way of example. In the second modification, a noise reduction process using the foregoing technique is applied to a reproduced signal of an audio signal recorded in the HDD 9.

As shown in FIG. 17, the video camera system 75 according to the second modification further includes a memory 76 in which a reduction-process control program 76a readable by the system controller 10 is stored. In the second modification, the system controller 10 controls the individual sections so that a noise reduction process is performed during reproduction rather than during recording in the manner described above according to the reduction-process control program 76a stored in the memory 76.

As indicated by the audio signal processor 4 (30, 35, 40, 46, 51, 60, 65, or 70) shown in FIG. 17, the second modification can be used for any of the various noise reduction processing techniques described above.

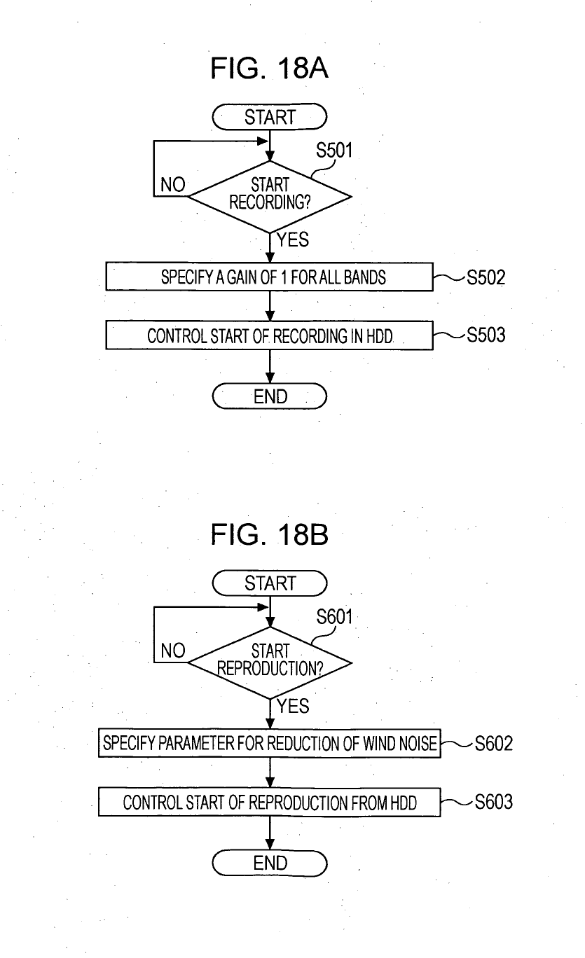

FIGS. 18A and 18B are flowcharts showing processing operations performed by the system controller 10 according to the reduction-process control program 76a. FIG. 18A shows the processing operation performed during recording, and FIG. 18B shows the processing operation performed during reproduction.

Referring first to FIG. 18A, in step S501, the process waits for a recording operation to start. For example, the process waits for generation of a trigger signal for starting a recording operation, such as a command signal supplied by operating the recording start button provided on the operation unit 12 shown in FIG. 17.

If it is determined that a recording operation is to be started by, for example, operating the recording start button, in step S502, an instruction for setting the gains for all bands to 1 is issued. In a case where the video camera system 75 shown in FIG. 17 includes an audio signal processor (40, 60, 65, or the like) provided with a wind noise detection/gain adjustment circuit (45, 61, 66, or 72), like the audio signal processor 40 according to the fourth example of the first embodiment, a gain instruction signal for setting the gains of all the gain units 43 to 1 is supplied to the wind noise detection/gain adjustment circuit using a control signal CNT shown in FIG. 17. Alternatively, in a case where the video camera system 75 shown in FIG. 17 includes an audio signal processor provided with the gain unit 25, like the audio signal processor 4 according to the first example of the first embodiment, a gain instruction signal for setting a gain of 1 is supplied to the gain unit 25 using a control signal CNT.

In step S503, the start of recording in an HDD is controlled. Specifically, the input changeover switches SW-L1 and SW-R1 and the output changeover switches SW-L2 and SW-R2 are controlled to select the terminals t2 so that the video and audio signals from the encoder 8 are recorded in the HDD 9.

In the reproduction process shown in FIG. 18B, first, in step S601, the process waits for a reproduction operation to start. For example, the process waits for generation of a trigger signal for starting a reproduction operation, such as a command signal supplied by operating the reproduction start button provided on the operation unit 12.

If it is determined that a reproduction operation is to be started by, for example, operating the reproduction start button, in step S602, a parameter is specified so that wind noise is reduced. In a case where the video camera system 75 shown in FIG. 17 includes an audio signal processor provided with the separation circuit 20 and the gain unit 25, like the audio signal processor 4 according to the first example of the first embodiment, or an audio signal processor provided with the wind noise detection/gain adjustment circuit 45, like the audio signal processor 40 according to the fourth example of the first embodiment, an angle instruction signal and a gain instruction signal for setting a gain smaller than at least 1 are supplied using a control signal CNT shown in FIG. 17.

Alternatively, in a case where the video camera system 75 shown in FIG. 17 includes an audio signal processor provided with a wind noise detection/gain adjustment circuit configured to perform the reduction process of the second embodiment, such as the wind noise detection/gain adjustment circuit 61, or a wind noise detection/gain adjustment circuit configured to perform the reduction process of the third embodiment, such as the wind noise detection/gain adjustment circuit 66, a reduced-threshold-value instruction signal and a gain instruction signal for setting a gain smaller than at least 1 are supplied using a control signal CNT.

Then, in step S603, the start of reproduction from an HDD is controlled. Specifically, the input changeover switches SW-L1 and SW-R1 and the output changeover switches SW-L2 and SW-R2 are controlled to select the terminals t3 so that the video and audio signals recorded in the HDD 9 are reproduced and output through the decoder 15.

With the above processing operations, a picked-up audio signal is recorded as it is during recording, and, during reproduction, the noise reduction process can be applied to a reproduced signal.

In the foregoing description, a reproduced signal subjected to the noise reduction process is output through the speakers SP. A signal obtained by performing the reduction process on a reproduced signal may be recorded again. In this case, the output changeover switches SW-L2 and SW-R2 may be controlled to select the terminals t2 so that an audio signal subjected to the reduction process is recorded in the HDD 9 through the encoder 8.

### Third Modification

A third modification will now be described.

In the third modification, a volume level of wind noise is estimated and a noise reduction processing parameter is changed according to the estimated volume level. A video camera system 80 according to the third modification, which is based on the video camera system 75 according to the second modification configured to perform a reduction process during reproduction, will be described by way of example.

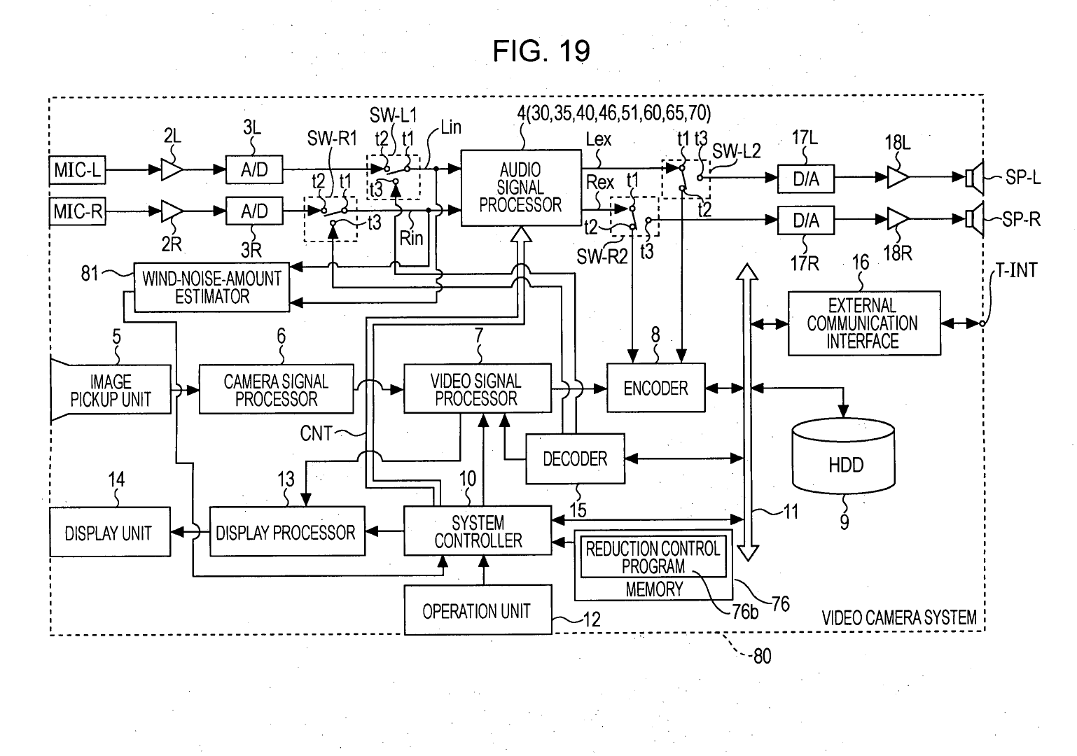

FIG. 19 shows an internal structure of the video camera system 80 according to the third modification. In FIG. 19, parts corresponding to the parts described above are denoted by the same reference numerals and a description thereof is omitted.

As shown in FIG. 19, the video camera system 80 further includes, in addition to the configuration of the video camera system 75 shown in FIG. 17, a wind-noise-amount estimator 81 configured to receive the audio signals Lin and Rin and to estimate (or determine) an amount of wind noise. The memory 76 stores a reduction-process control program 76b for implementing a process according to the third modification described below.

The wind-noise-amount estimator 81 may be any of various types of circuits having a function for estimating a volume level of wind noise from Lch and Rch audio signals. For example, the circuit described in Japanese Patent No. 3186892 noted above or the like may be used. The circuit described in this publication generates a difference component between Lch and Rch audio signals, extracts one of the Lch and Rch signals that has a lower correlation, and apply an LPF to the extracted signal to estimate the volume level of wind noise.

The wind-noise-amount estimator 81 may be configured to determine a volume level of wind noise for every predetermined time unit such as frame unit, and the results are sequentially supplied to the system controller 10.

In the recording process, the system controller 10 sequentially associates the input volume levels of wind noise that change over time (also referred to simply as “wind noise amounts”) with time information (in this case, each frame number) to generate noise-amount-time-correspondence information, and records the generated noise-amount-time-correspondence information in the HDD 9.

In the reproduction process, the noise-amount-time-correspondence information is read, and then noise reduction processing parameters are sequentially determined according to the wind noise amounts associated with the time information (frame numbers). The determined parameters are sent to the audio signal processor 4 (30, 35, 40, 46, 51, 60, 65, or 70) using a control signal CNT.

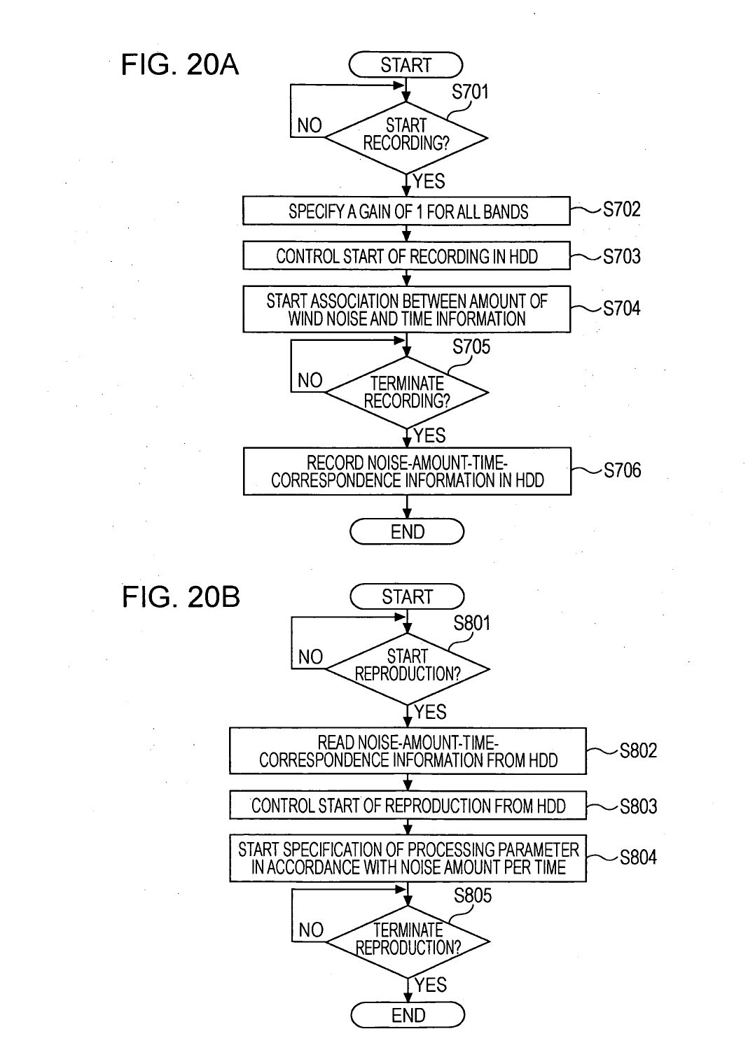

FIGS. 20A and 20B are flowcharts showing processing operations executed to implement the operation of the video camera system 80 according to the third modification. FIG. 20A shows the processing operation performed during recording, and FIG. 20B shows the processing operation performed during reproduction.

It is to be noted that the processing operations shown in FIGS. 20A and 20B are executed by the system controller 10 shown in FIG. 19 according to the reduction-process control program 76b.

Referring to FIG. 20A, in steps S701, S702, and S703, the processing similar to that of steps S501, S502, and S503 shown in FIG. 18A is executed to perform control so that an operation of recording a picked-up audio signal as it is in the HDD 9 is started in response to a recording start signal.

In step S704, the association between a wind noise amount and time information is started. Specifically, a process for associating information about a wind noise amount sequentially supplied for every frame unit from the wind-noise-amount estimator 81 with information about a frame number is started.

In step S705, the process waits for termination of the recording operation. For example, the process wais for generation of a trigger signal for terminating a recording operation, such as a command signal supplied by operating the recording stop button provided on the operation unit 12 shown in FIG. 19.

If it is determined that the recording operation is to be terminated by, for example, operating the recording stop button, in step S706, noise-amount-time-correspondence information is recorded in an HDD. Specifically, the noise-amount-time-correspondence information generated by the association process started in step S704, which indicates the correspondence between each frame and a noise amount for the corresponding frame, is recorded in the HDD 9.

In the reproduction process shown in FIG. 20B, if it is determined in step S801 that a reproduction operation is to be started, in step S802, the noise-amount-time-correspondence information recorded in the HDD 9 in the manner described above is read.

In step S803, processing similar to that of step S603 shown in FIG. 18B is performed to start the reproduction of the video and audio signals from the HDD 9.

Then, in step S804, a processing parameter is started to be specified in accordance with a noise amount per time. Specifically, parameters (processing parameters) for the reduction process are determined from the wind noise amounts sequentially associated with the time information (frame numbers) on the basis of the noise-amount-time-correspondence information read in the manner described above, and the determined parameters are sent to the audio signal processor 4 (30, 35, 40, 46, 51, 60, 65, or 70) using a control signal CNT.

In step S805, the process waits for generation of a trigger signal for terminating the reproduction operation, such as a command signal supplied by, for example, operating the reproduction stop button on the operation unit 12. Then, in accordance with the generation of the trigger signal, the processing operation shown in FIG. 20 ends.

An exemplary technique for determining a processing parameter on the basis of a wind noise amount in step S804 will now be described.

First, by way of example, a predetermined threshold value is used to determine whether or not a wind noise amount is less than or equal to the threshold value. If the wind noise amount is less than or equal to the threshold value, a gain value to be specified by a gain instruction signal is determined to be 1. If the wind noise amount is greater than the threshold value, a gain value to be specified by a gain instruction signal is determined to be a desired value smaller than 1.

Accordingly, if a wind noise amount is less than or equal to a predetermined value, the gains of all bands are set to 1 so that the noise reduction process may not be performed. If a wind noise amount is relatively large, the noise reduction process can appropriately be performed.

Alternatively, a gain value to be specified by a gain instruction signal may be determined to be a smaller value depending on the magnitude of a wind noise amount. This can control the intensity of the noise reduction effect according to the wind noise amount.

Alternatively, a processing parameter to be determined according to a wind noise amount may be not only a gain value specified by a gain instruction signal but also any other parameter to be specified for the reduction process, such as a localization angle (first embodiment) specified by a localization angle instruction signal or a threshold value (second or third embodiment) specified by a reduced-threshold-value instruction signal.

For example, if a wind noise amount is small, a localization angle to be specified by a localization angle instruction signal may be set to a larger value (so that only a signal component that is localized more outside can be detected as a wind noise component), or a threshold value to be specified by a reduced-threshold-value instruction signal may be set to a larger value (so that only a signal component having a larger shift amount or localization angle difference can be detected as a wind noise component).

In the foregoing examples, information about a determined (or estimated) wind noise amount is recorded in a separate file from an audio signal to be recorded, by way of example. However, the information about a wind noise amount may be recorded so as to be superimposed on an audio signal (e.g., recorded as metadata or the like).

In the foregoing description, the noise reduction process is performed during reproduction using the third modification, by way of example. It is to be understood that the third modification is also applicable to a case where the reduction process is performed in real time on a picked-up audio signal during recording. In this case, the system controller 10 is configured to determine a processing parameter in real time from information about a wind noise amount for a current frame that is supplied from the wind-noise-amount estimator 81, and to send the result to the audio signal processor 4 (30, 35, 40, 46, 51, 60, 65, or 70) using the control signal CNT.

A further modification of the third modification may include the following operation.

For example, in the foregoing examples, when recorded video and audio signals are reproduced and output according to a reproduction start instruction, the reduction process using a processing parameter corresponding to a wind noise amount is performed. Alternatively, for example, in a state where the apparatus does not perform any other processing, an audio signal may be automatically reproduced from the HDD 9, the reproduced signal may be subjected to the reduction process using a processing parameter corresponding to a wind noise amount, and the result may be recorded again in the HDD 9.

Furthermore, for example, in the recording process, a processing parameter may be determined and specified in real time according to the wind noise amount determined by the wind-noise-amount estimator 81, and the noise reduction process may be performed on a picked-up audio signal. Thereafter, also when the recorded picked-up audio signal is reproduced, a wind noise amount for the reproduced signal may be determined in real time by the wind-noise-amount estimator 81 to determine and specify a processing parameter to thereby perform the noise reduction process.

Alternatively, likewise, in the recording process, a processing parameter may be determined and specified in real time according to the wind noise amount determined by the wind-noise-amount estimator 81, and the noise reduction process may be performed on a picked-up audio signal. Thereafter, for example, in a state where the apparatus does not perform any other processing, the recorded picked-up audio signal may be automatically reproduced from the HDD 9, and a wind noise amount for the reproduced signal may be determined again by the wind-noise-amount estimator 81 to determine and specify a processing parameter in real time to thereby perform the noise reduction process. The result may be recorded again in the HDD 9.

Furthermore, such an automatic reproduction after recording, determination of a wind noise amount of a reproduced signal, and noise reduction processing based on a processing parameter accordingly may be repeated a plurality of times. In a case where the reduction-process after recording is repeated, a processing parameter is changed according to a wind noise amount that sequentially changes each time the processing is repeated. Thus, the processing parameter can be optimized, resulting in an audio signal from which wind noise is most reduced.

The estimation (or determination) of a wind noise amount may be performed, instead of on the audio signals Lin and Rin that are directly input in the manner shown in FIG. 19, for example, by determining a volume level of a sub-band signal that is determined to be a wind noise component in the reduction process.

It is to be noted that a signal processing apparatus according to the third modification includes an audio signal processor, the wind-noise-amount estimator 81, and the system controller 10 (a section configured to change a parameter according to a wind noise amount).

### Other Modifications

In the foregoing description, a wind noise reduction process is performed under a condition of a frequency range of 1 kHz or less. However, this is merely an example, and wind noise reduction process may be performed under a condition of a frequency band less than or equal to a predetermined frequency, which is assumed to be at least a primary frequency range of a wind noise component, such as a frequency range of 800 Hz or less.

Further, in the foregoing description, mainly, wind noise reduction process is performed on two-channel audio signals, i.e., Lch and Rch audio signals, by way of example. Any number of channels of signals more than one channel may be used. For example, five-channel signals may be used.

In the foregoing description, furthermore, the noise reduction techniques of the first, second, and third embodiments are independently used by way of example. However, all of a portion of those techniques may be used in combination.

For example, the techniques of the first and second embodiments may be combined so that a signal component that is localized outside a specified localization angle and that is a signal component having a frequency less than or equal to a predetermined frequency and having a localization position that is shifted in the time axis direction by an amount greater than a specified amount is reduced. Alternatively, instead of such an AND condition, an OR condition may be used. That is, a signal component that is localized outside a specified localization angle or that is a signal component having a frequency less than or equal to a predetermined frequency and having a localization position that is shifted in the time axis direction by an amount greater than a specified amount is reduced.

In the foregoing description, moreover, wind noise reduction processing of the individual sections (e.g., determination of a localization angle, multiplication of a gain, etc.) is performed for every predetermined processing segment such as every frame unit. This is because it is greatly difficult to process a long time-series signal such as music without segmenting the signal when an audio signal is divided into frequency bands.

However, in a case where an audio signal is processed for every predetermined processing segment, a discontinuous waveform might be generated at a connection portion in the processed signal, and the risk of inducing noise might be increased.

In an actual implementation, therefore, it is effective that the processing segments overlap. For example, an audio signal is divided into segments so that adjacent segments overlap each other by a length of half. In this case, a signal subjected to noise reduction process also has overlapping segments, and is not therefore output as it is. Thus, overlapping portions of signals of two adjacent segments, e.g., signals of segments 1 and 2, are subjected to processing using desired window functions, and then signals of both segments are summed synchronously. Therefore, a high-quality output audio signal in which the occurrence of discontinuous points in a waveform is prevented can be obtained.

Examples of the window functions include a triangular window, a Hanning window, and a Hamming window.

In the foregoing description, furthermore, particularly in the first embodiment, sound sources localized within and outside a localization angle that is determined according to an instruction from the system controller 10 are separated by way of example. Instead of sound sources localized within and outside a localization angle determined according to an instruction, sound sources localized within and outside a predetermined fixed localization angle may be separated.

In the foregoing example structures, a gain specified from the system controller 10 is multiplied for reduction of wind noise. Instead of multiplication of such a specified gain, a fixed gain may be multiplied.

Noise reduction processing parameters such as a localization angle and a gain may be partly or entirely set by a user's operation. For example, the operation unit 12 may be provided with a handler capable of specifying and entering a gain value. For example, when the handler is operated by a user such as a photographer, the system controller 10 may determine and specify a gain value to more flexibly adjust a gain value for reduction (i.e., a level at which wind noise is to be reduced) by an operation.

Furthermore, as is to be understood from the foregoing. description, when wind noise is reduced, no reduction process is performed on a signal component in a frequency range more than or equal to a predetermined frequency. Thus, such a frequency range is not divided into sub-bands. In addition, explicit gain multiplication processing for that frequency range may also be omitted (i.e., multiplication of a gain of 1 may be omitted).

In the foregoing description, furthermore, a gain of a noise component is set smaller than 1, and other components are set to a gain of 1, thereby reducing the noise component by way of example. The gains may be adjusted so that a noise component can be relatively reduced, and the values of the gains are not limited to a specific value.

While the foregoing embodiments of the present invention have been described in the context of a signal processing apparatus applied to a video camera system capable of video and audio recording by way of example, an embodiment of the present invention may also be applied to an audio recording apparatus capable of only audio recording, such as a voice recorder, or a reproduction apparatus capable of performing reproduction, such as a personal computer or a DVD recorder (or HDD recorder).

In a case where a device, such as the personal computer described above, performs wind noise reduction processing on a picked-up audio signal (audio signal) that is not picked up within the device but is input from an external device, the input audio signal may be in a signal form that is not compatible with the device. In such a case, it is determined whether or not a target audio signal to be subjected to noise reduction processing is in a format compatible with the device (e.g., whether or not the sampling frequency of the target audio signal is supported by the device). If it is determined that the target audio signal is not compatible, an additional process for converting the target audio signal into a processible signal format (e.g., converting the sampling frequency) may be performed. Such determination and conversion processing may be performed by the system controller 10 upon receiving the audio signals Lin and Rin, or may be implemented by providing an additional section adapted to perform the processing before or within the audio signal processor 4 (30, 35, 40, 46, 51, 60, or 65).

In the foregoing embodiments, the programs for implementation in software are provided through a recording medium having the programs recorded thereon or a network. The recording medium may be any type that allows a signal processing apparatus to read the programs, and may include, but not limited to, an optical disk such as a semiconductor memory or a compact disc read-only memory (CD-ROM), and a magnetic disk.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing apparatus comprising:
receiving means for receiving an audio signal; and
noise reducing means for reducing a wind noise component of the audio signal received by the receiving means by reducing a signal component that has a frequency less than or equal to a predetermined frequency and that is localized in a different manner from a specified manner.

2. The signal processing apparatus according to claim 1, wherein the signal component is localized outside a specified localization angle.

3. The signal processing apparatus according to claim 2, wherein the noise reducing means divides a low-frequency range of the audio signal into a plurality of frequency bands, the low-frequency range of the audio signal being a frequency range less than or equal to the predetermined frequency, and determines a localization angle of a signal of each of the plurality of frequency bands, and
the noise reducing means reduces a first signal in a first frequency band that is less than or equal to the predetermined frequency and that is localized outside the specified localization angle to reduce the wind noise component.

4. The signal processing apparatus according to claim 1, wherein the signal component has a localization angle changing in a different manner from a specified manner in a time axis direction.

5. The signal processing apparatus according to claim 4, wherein the noise reducing means divides a low-frequency range of the audio signal into a plurality of frequency bands, the low-frequency range of the audio signal being a frequency range less than or equal to the predetermined frequency, and analyzes a manner in which a localization angle of a signal for each of the plurality of frequency bands changes in the time axis direction, and
the noise reducing means reduces a first signal in a first frequency band that is less than or equal to the predetermined frequency and for which the manner in which the localization angle of the signal component changes in the time axis direction is different from the specified manner to reduce the wind noise component.

6. The signal processing apparatus according to claim 1, wherein the noise reducing means reduces the signal component when a difference between a localization angle of the signal component and a localization angle of a second signal component in an adjacent frequency band is greater than a predetermined value.

7. The signal processing apparatus according to claim 6, wherein the noise reducing means divides a low-frequency range of the audio signal into a plurality of frequency bands, the low-frequency range being a frequency range less than or equal to the predetermined frequency, and analyzes a difference in localization angle between each of the frequency bands and a frequency band adjacent thereto, and
the noise reducing means reduces a first signal component in a first frequency band for which a difference in localization angle between the frequency band and a second frequency band adjacent thereto is greater than the predetermined value to reduce the wind noise component.

8. The signal processing apparatus according to claim 1, wherein the noise reducing means determines a localization angle on the basis of at least one of a level ratio of a right-channel signal to a left-channel signal of the audio signal and a phase difference between the right-channel signal and the left-channel signal.

9. A signal processing apparatus comprising:
receiving means for receiving an audio signal; and
noise reducing means for reducing a wind noise component of the audio signal received by the receiving means by reducing a signal component that has a frequency less than or equal to a predetermined frequency and that has a localization angle with a low correlation in a time axis direction.

10. A signal processing apparatus comprising:
receiving means for receiving an audio signal; and
noise reducing means for reducing a wind noise component of the audio signal received by the receiving means by reducing a signal component that has a frequency less than or equal to a predetermined frequency and that has a localization angle with a low correlation with an adjacent frequency band.

11. A signal processing method comprising:
reducing a wind noise component of an input audio signal by reducing a signal component that has a frequency less than or equal to a predetermined frequency and that is localized in a different manner from a specified manner.

12. A signal processing method comprising:
reducing a wind noise component of an input audio signal by reducing a signal component that has a frequency less than or equal to a predetermined frequency and that has a localization angle with a low correlation in a time axis direction.

13. A signal processing method comprising:
reducing a wind noise component of an input audio signal by reducing a signal component that has a frequency less than or equal to a predetermined frequency and that has a localization angle with a low correlation with an adjacent frequency band.

14. A recording medium having a program recorded thereon, the program causing a signal processing apparatus to execute a process comprising:
reducing a wind noise component of an input audio signal by reducing a signal component that has a frequency less than or equal to a predetermined frequency and that is localized in a different manner from a specified manner.

15. A recording medium having a program recorded thereon, the program causing a signal processing apparatus to execute a process comprising:
reducing a wind noise component of an input audio signal by reducing a signal component that has a frequency less than or equal to a predetermined frequency and that has a localization angle with a low correlation in a time axis direction.

16. A recording medium having a program recorded thereon, the program causing a signal processing apparatus to execute a process comprising:
reducing a wind noise component of an input audio signal by reducing a signal component that has a frequency less than or equal to a predetermined frequency and that has a localization angle with a correlation with an adjacent frequency band.

17. A signal processing apparatus comprising:
a receiving unit configured to receive an audio signal; and
a noise reducing unit configured to reduce a wind noise component of the audio signal received by the receiving unit by reducing a signal component that has a frequency less than or equal to a predetermined frequency and that is localized in a different manner from a specified manner.

18. A signal processing apparatus comprising:
a receiving unit configured to receive an audio signal; and
a noise reducing unit configured to reduce a wind noise component of the audio signal received by the receiving unit by reducing a signal component that has a frequency less than or equal to a predetermined frequency and that has a localization angle with a low correlation in a time axis direction.

19. A signal processing apparatus comprising:
a receiving unit configured to receive an audio signal; and
a noise reducing unit configured to reduce a wind noise component of the audio signal received by the receiving unit by reducing a signal component that has a frequency less than or equal to a predetermined frequency and that has a localization angle with a low correlation with an adjacent frequency band.
